(19) United States
(12) Patent Application Publication
(10) Pub. No.: US 2018/0075122 A1
(43) Pub. Date: Mar. 15, 2018

(54) Method to Federate Data Replication over a Communications Network

(71) Applicants: RICHARD BANISTER, ESCONDIO, CA (US); WILLIAM DUBBERLEY, PULASKI, TN (US)

(72) Inventors: RICHARD BANISTER, ESCONDIO, CA (US); WILLIAM DUBBERLEY, PULASKI, TN (US)

(21) Appl. No.: 15/818,645

(22) Filed: Nov. 20, 2017

Related U.S. Application Data
(63) Continuation-in-part of application No. 14/680,046, filed on Apr. 6, 2015, now abandoned.

(51) Int. Cl. G06F 17/30; H04L 29/08

(52) U.S. Cl. CPC G06F 17/30575; G06F 17/30371; H04L 67/1095; H04L 67/141; G06F 17/30483

(57) ABSTRACT

A method and system enable acceleration of high performance data replication over an Internet connection by means of parallel processes. Scalability of data replication is enhanced both by means of parallel queries as subtasks of a main controller, and by wrapping the queries in date time stamp-bounded ranges, requesting only records falling within the specific times indicated by the date time stamp. By wrapping the queries, the number of records per pass is limited, enhancing the efficiency of each pass. The reduced number of records per pass further facilitates re-initiation of data replication upon failure, because fewer records are less burdensome for a computing system to attempt to transmit and/or receive multiple times. Also presented is a method by which a client may query a remote server for record keys, in place of full records, such that the client and server need process less data.

This Nonprovisional patent application is a Continuation-in-Part application to U.S. Nonprovisional patent application Ser. No. 14/680,046 as filed on Apr. 6, 2015 by Inventors Richard Banister and William Dubberley and titled Method to Federate Data Replication over a Communications Network. This Nonprovisional patent application claims benefit of the priority date of U.S. Nonprovisional patent application Ser. No. 14/680,046. U.S. Nonprovisional patent application Ser. No. 14/680,046 is incorporated into this Nonprovisional patent application in its entirety and for all purposes.

### FIELD OF THE INVENTION

The present invention relates to the relatedness of two or more databases that are within an electronic communications network. More particularly, the invented method relates to copying large amounts of data from one computing device to another via the Internet.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Data replication in network computing involves sharing information among systems addressable via an electronics communications network so as to ensure consistency between redundant resources, such as software or hardware components, to improve service reliability, multi-system fault-tolerance, or local accessibility to data. Many classical approaches to replication are based on a primary/backup model where one device or process has unilateral control over one or more other processes or devices. For example, the primary might perform some computation, streaming a log of updates to a backup (standby) process, which can then take over if the primary fails. This approach is the most common one for replicating databases, despite the risk that if a portion of the log is lost during a failure, the backup might not be in a state identical to the one the primary was in, and transactions could then be lost.

Modern economies and much of modern life rely upon the reliable, accurate and timely updating of two or more versions or instances of information and/or database records stored in distinct and separate databases contained within, or addressable by, federated databases or other communicatively linked databases. This database record updating of databases meant to contain that requires replication of database records and updates thereof to maintain accuracy and provide data integrity. According to research presented by Cisco Systems, Inc. of San Jose, Calif., 14,000 petabytes of IP traffic was dedicated to file sharing in calendar year 2015. It is therefore clear that any significant improvement in the speed and reliability, or reduction in computational burden, of data record updating processes suitable for the Internet, digital telephony networks or other electronic communications networks would powerfully advance the art of digital communications and electronic network operations.

The prior art enables the transfer of large amounts of data across the Internet between computational systems to replicate data records and less often entire databases. Replication of information contained in database records generally presents the challenge of providing data update information in order to keep two or more databases current which information newly integrated into one or more of the related or mirroring databases. Yet the prior art fails to provide optimal systems and methods by which the database update information may be transferred. The querying, requesting, and transfer processes of database update management and replication coordination as they currently exist are slower than desired and often prone to stoppage, without an effective means of recovering from database record update transfer stalls and/or failures. There is therefore a long-felt need to provide a method and system that provide increased efficiencies of electronic transmission of large amounts of data over an electronics communications network for inclusion in existing database records as update information and/or for population of database records.

### SUMMARY AND OBJECTS OF THE INVENTION

Towards these objects and other objects that will be made obvious in light of the present disclosure, a system and method are provided that enable transfer and replication of electronic data between communicatively coupled computing devices. The method of the present invention (hereinafter, “the invented method”) involves a first computing device querying a second computing device for a plurality of software record keys, wherein one or more software record keys may be selected based upon an initial and final date time stamp. The software record keys may be divided into query files, and subsequently replicated by means of a plurality of simultaneous replication processes involving transmission of a plurality of records from the second computing device to the first computing device. Optionally, certain alternate preferred embodiments of the invented method enable a limitation of providing no more than a designated count of ordered record keys, wherein the plurality of selected record keys is ordered in accordance with primary key values of each selected record, wherein each selected key is indicated to have been last updated within a specified time and date range.

A plurality of software record keys are provided to the first computing device following a record update query received by the second computing device. The second computing device may optionally or additionally receive a plurality of record update replication process requests. The second computing device engages in a replication process whereby the second computing device provides software record keys associated with database record updates to the first computer device.

According to alternate embodiments of the invented method, an invented computational device is provided. The invented computational device (hereinafter, “the invented device”) includes: a memory coupled with a processor, wherein both the memory and the processor enable a database management software; a means to determine the initial and final time date stamps; a means to submit one or more software data update query to the second computational device; a means to receive one or more software data keys from the second computational device; the means to engage in one or more parallel replication processes; means to direct a remote data source via an electronics communications network to send a limited number of record keys associated with record updates indicated to have occurred within a specified time bounds; means to direct a remote data source via an electronics communications network to send a information related to record updates indicated to have occurred within a specified time bounds; and/or means to dynamically record and maintain a record key of a last received record key during a plurality of discrete downloads of ordered record keys from a remote source via a computer network.

This Summary is provided to introduce a selection of concepts in a simplified form that are further described below in the Detailed Description. Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE FIGURES

These, and further features of the invention, may be better understood with reference to the accompanying specification and drawings depicting the preferred embodiment, in which:

FIG. 1 is a diagram of an electronic communications network, comprising a client and a remote server, bidirectionally coupled by means of the Internet;

FIG. 2 is a flowchart of an aspect of the invented method whereby the client requests and receives keys from the remote server of FIG. 1, and subsequently replicates the keys;

FIG. 3 is a flowchart of a further aspect of the invented method whereby the server takes part in the round robin and fixed sequential replication processes;

FIGS. 4A-4B are flowcharts of a yet further aspect of the invented method whereby the client executes a round robin replication process;

FIGS. 5A-5B are flowcharts of an additional aspect of the invented method whereby the client executes a fixed-link sequential replication process;

FIG. 6 is a flowchart of a further aspect of the invented method whereby the server takes part in an incremented sequential replication process;

FIGS. 7A-7B are flowcharts of a further aspect of the invented method whereby the client executes an incremented sequential replication process;

FIG. 8 is a block diagram of the server of FIG. 1;

FIG. 9 is a block diagram of the client of FIG. 1;

FIG. 10 is a block diagram of an exemplary first key request message transmitted from the client to the server;

FIG. 11 is a block diagram of an exemplary first key-containing message transmitted from the server to the client;

FIG. 12 is a block diagram of an exemplary first key number query message transmitted from the client to the server;

FIG. 13 is a block diagram of an exemplary first key number containing message transmitted from the server to the client;

FIG. 14 is a block diagram of a first exemplary replication process;

FIG. 15 is a block diagram of an exemplary first download thread;

FIG. 16 is a block diagram of an exemplary first failure notification;

FIG. 17 is a block diagram of an exemplary first success notification.

FIG. 18 is a flowchart of an alternate preferred embodiment of the invented method wherein the client of FIG. 1 requests primary keys of records that have been updated within a specified time bounds and optionally requesting limited quantities of record keys in one or more server response messages from the remote server of FIG. 1;

FIG. 19 is a flowchart of aspects of the remote server of FIG. 1 in interaction with the client of FIG. 1 in accordance with the client operations of the method of FIG. 18.

FIG. 20 is a block diagram of the primary key request message of FIG. 18;

FIG. 21 is a block diagram of a server response message of FIG. 18;

FIG. 22 is a block diagram of a restart file of the method of FIG. 18; and

FIG. 23 is a block diagram of the client memory of FIG. 9 showing the record key lists as harvested from the server response messages of FIG. 18, FIG. 19 and FIG. 21 and stored in the client memory an additional client disk memory module further comprised within the client of FIG. 1.

### DETAILED DESCRIPTION

It is understood that the word “ ” is used herein to mean “serving as an example, instance, or illustration.” Any aspect described herein as “exemplary” is not necessarily to be construed as exclusive, preferred or advantageous over other aspects.

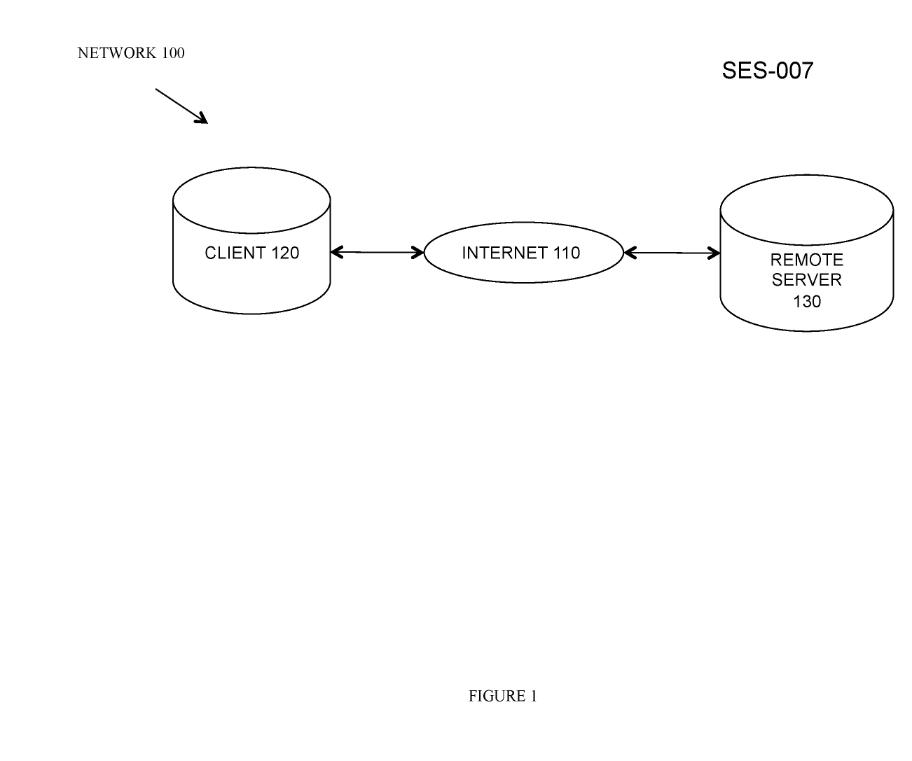

Referring now generally to the Figures and particularly to FIG. 1, FIG. 1 is a diagram of an electronic communications network 100, comprising a client 120 and a remote server 130, bidirectionally coupled by means of the Internet 110. The client 120, the remote server 130 each preferably comprise a separate database management system software, respectively a client DBMS 120A, and a remote server DBMS 130A.

The client DBMS 120A and/or the remote DBMS 130A may be or comprise an object oriented database management system (“OODBMS”) and/or a relational database management system (“RDBMS”). More particularly, the client DBMS 120A and/or the remote server DBMS 130A may be or comprise one or more prior art database management systems including, but not limited to, an ORACLE DATABASE™ database management system marketed by Oracle Corporation, of Redwood City, Calif.; a Database 2™, also known as DB2™, relational database management system as marketed by IBM Corporation of Armonk, N.Y.; a Microsoft SQL Server™ relational database management system as marketed by Microsoft Corporation of Redmond, Wash.; MySQL™ as marketed by Oracle Corporation of Redwood City, Calif.; and a MONGODB™ as marketed by MongoDB, Inc. of New York City, USA; and the POSTGRESQL™ open source object-relational database management system.

The remote server 130 may bi-directionally communicate and transfer data with the client 120 via the network 100 by suitable electronic communications messaging protocols and methods known in the art including, but not limited to, Simple Object Access Protocol, Representational State Transfer, and/or a webservice adapted to conform with the architecture and structure of the World Wide Web.

It is understood that the client 120 and the remote server 130 may be a software program hosted and/or enabled by, or may be or comprise a bundled computer software and hardware product such as, (a.) a network-communications enabled THINKSTATION WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running WINDOWS XP™ or WINDOWS 8™ operating system marketed by Microsoft Corporation of Redmond, Wash.; or (d.) other suitable computational system or electronic communications device known in the art capable of providing or enabling a financial web service known in the art.

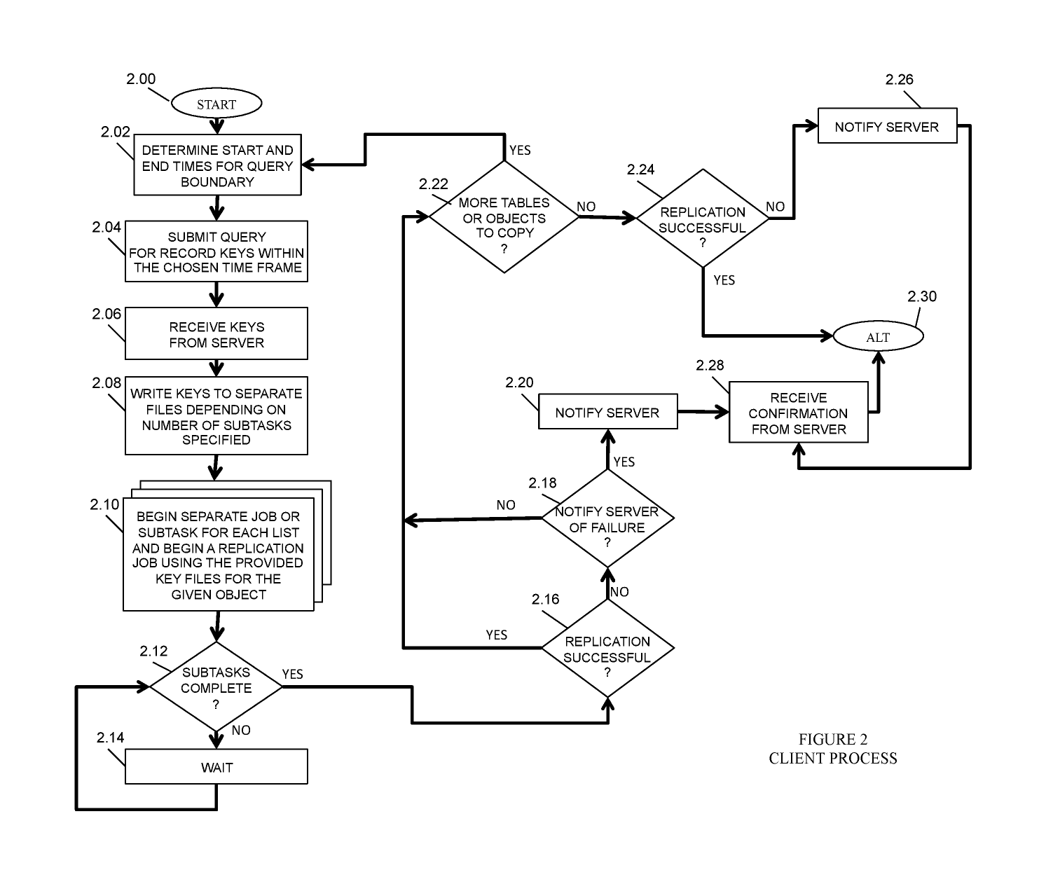

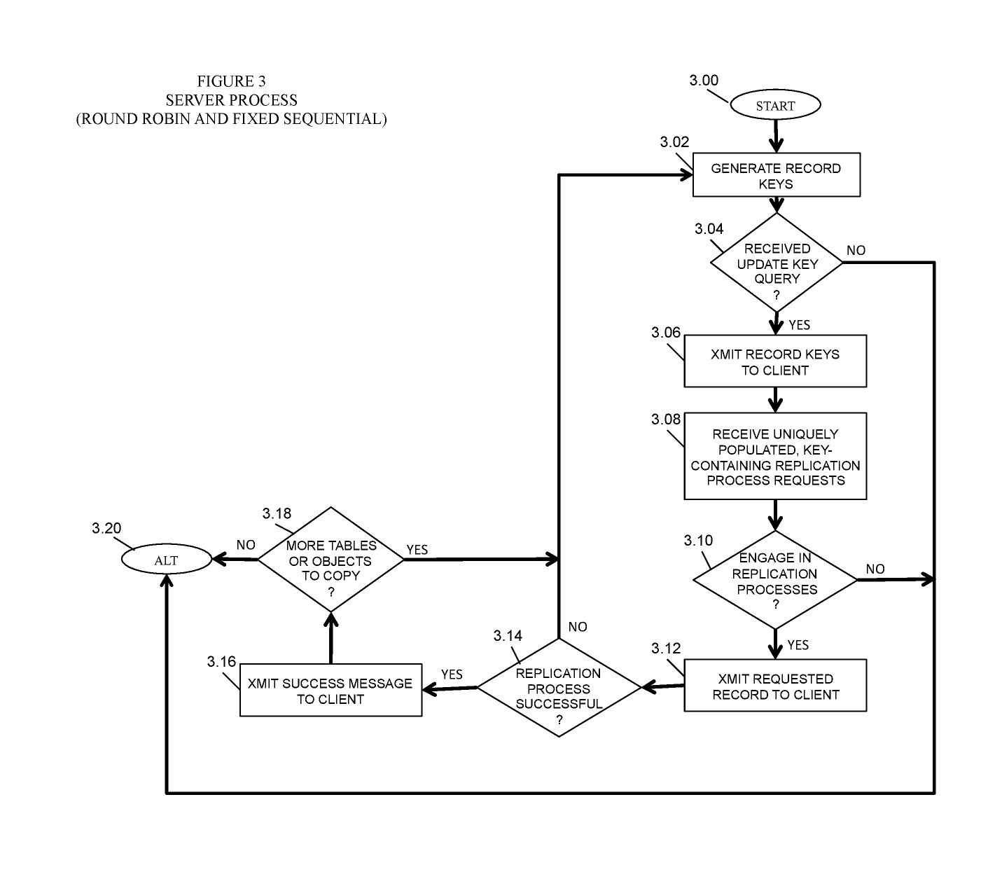

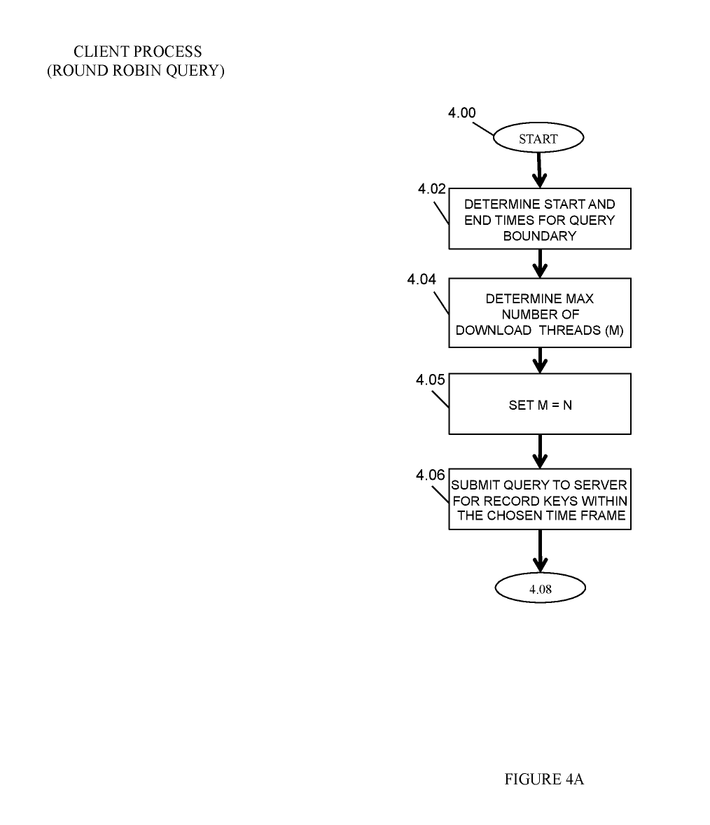

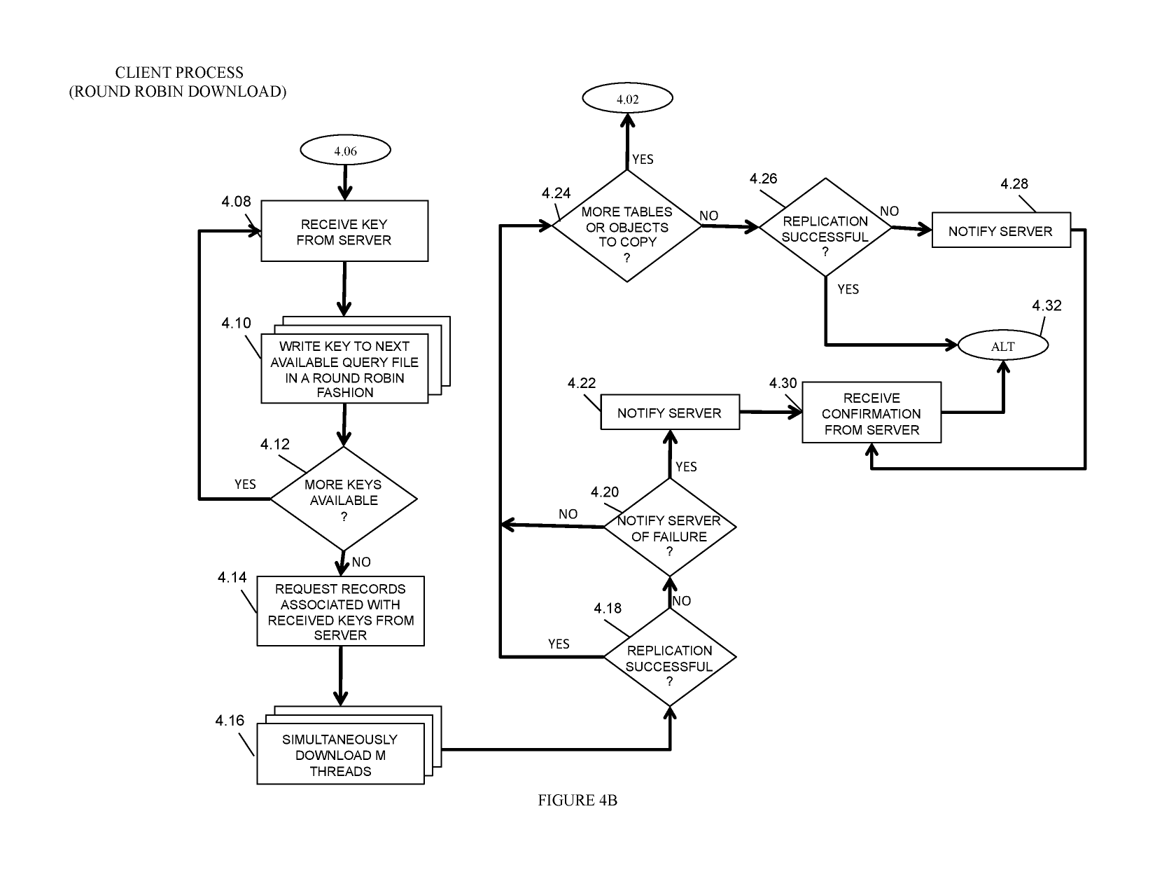

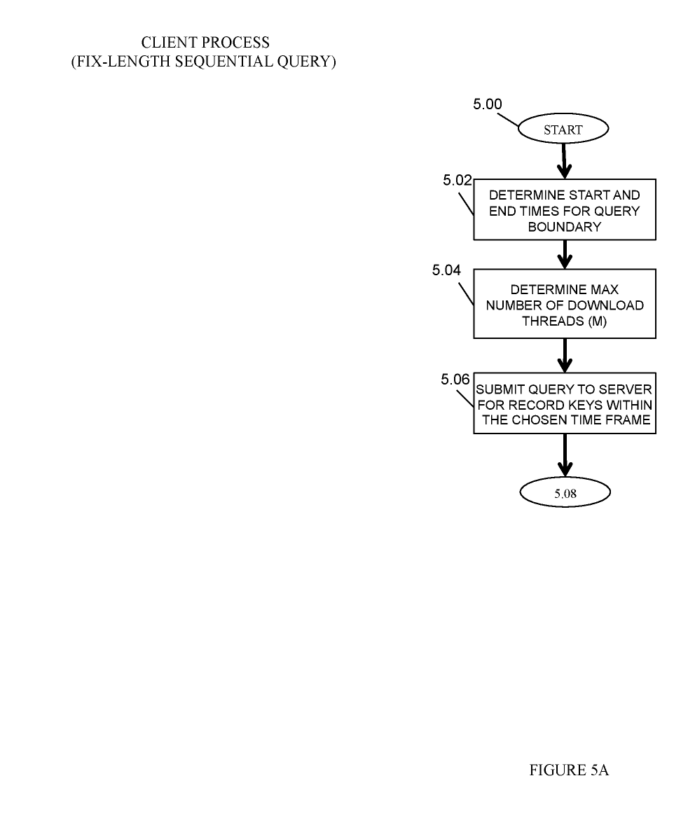

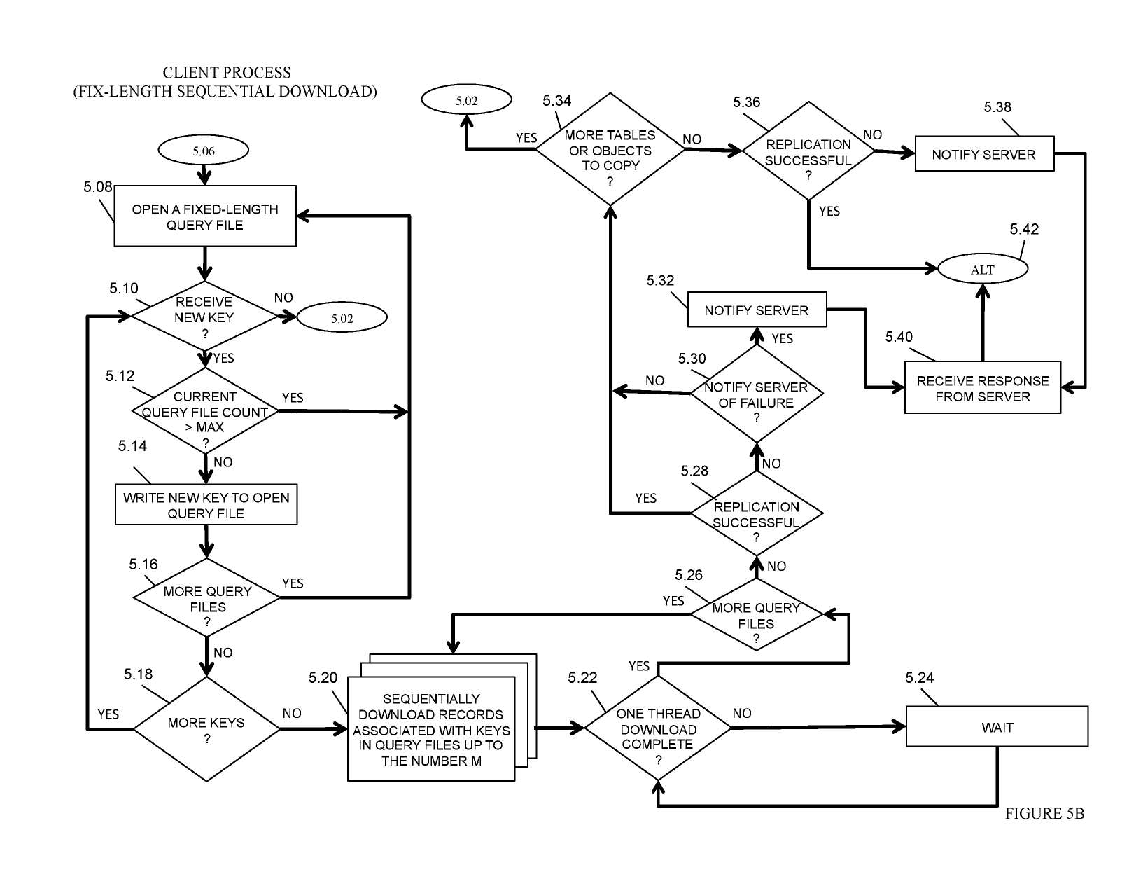

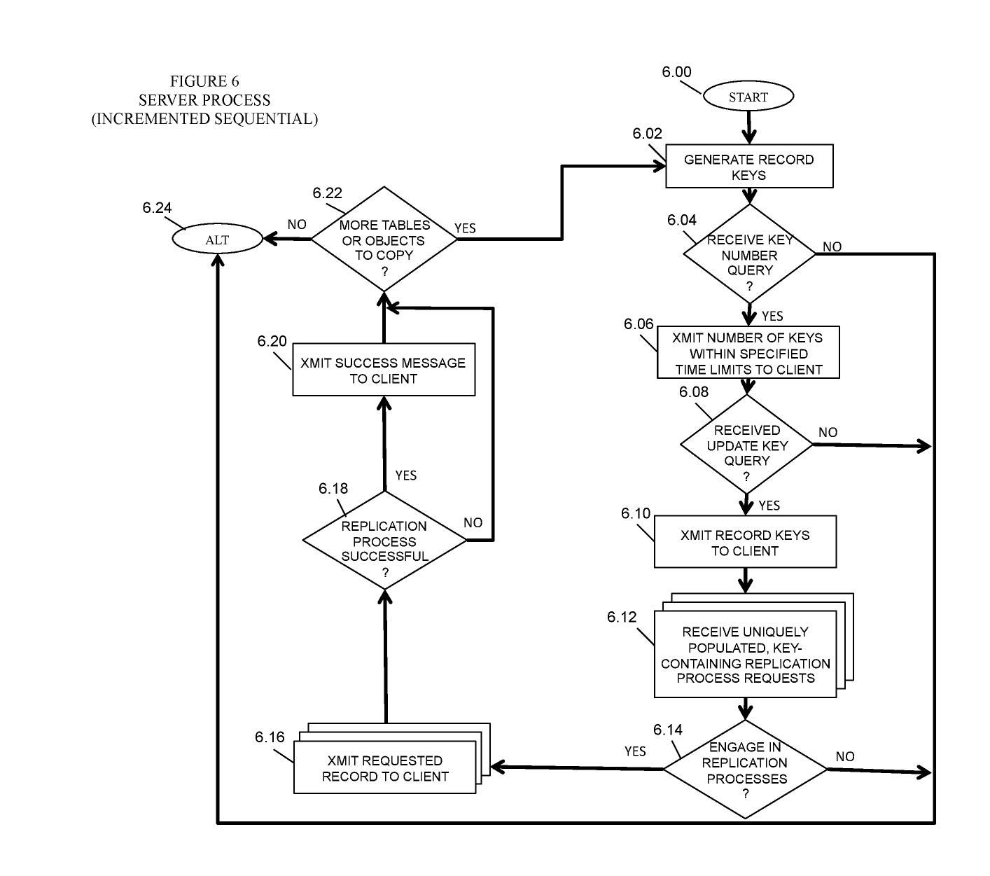

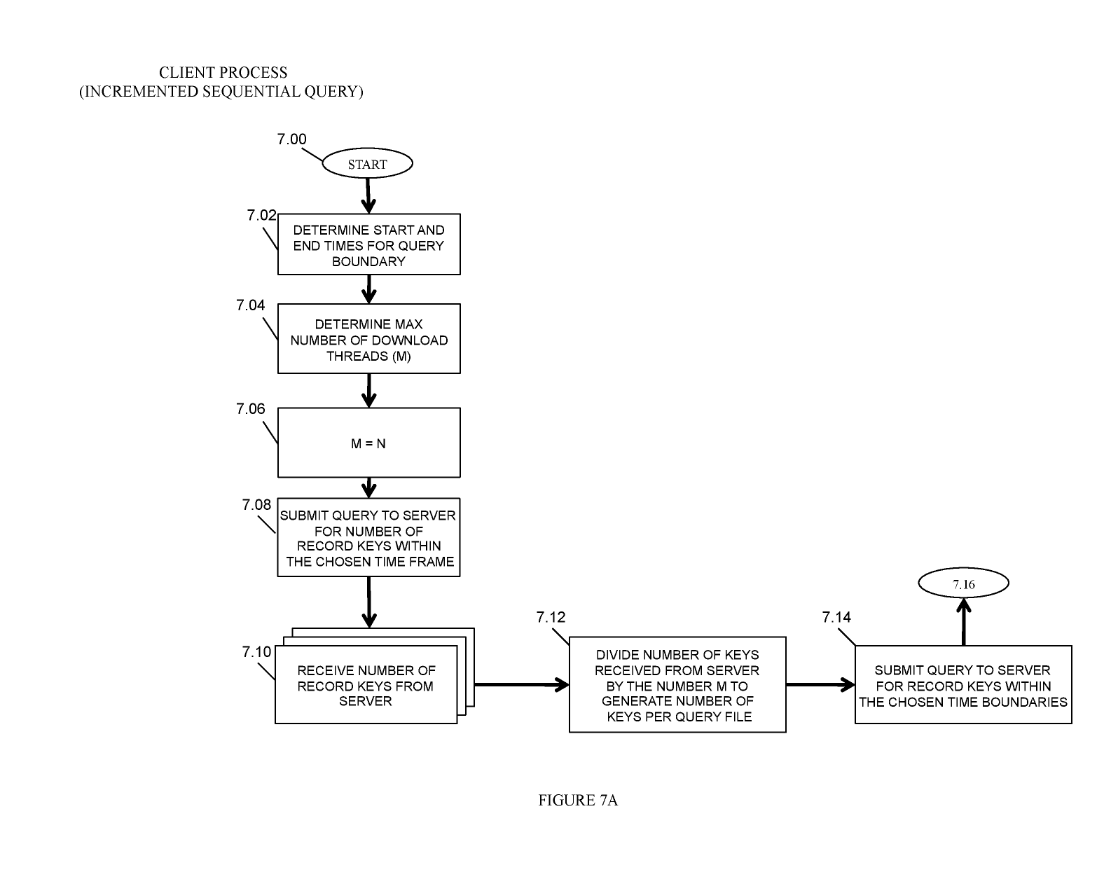

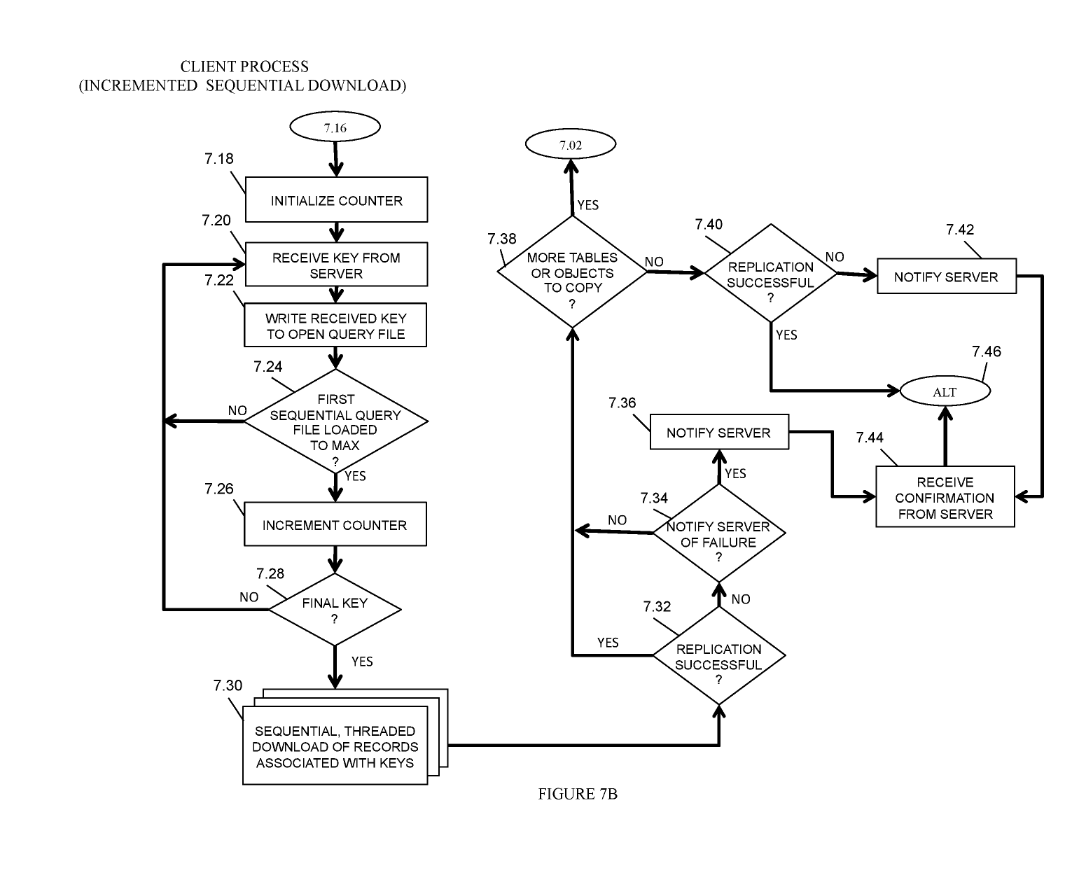

Referring now generally to the Figures, and particularly to FIG. 2, FIG. 2 is a flowchart of an aspect of the invented method whereby the client 120 requests and receives a plurality of software keys KEY.001-KEY.N from the remote server 130 of FIG. 1, and subsequently replicates the software keys KEY.001-KEY.N. The invented method comprises at least three embodiments, by which a plurality of query files QRF.001-QRF.N may be populated with software keys KEY.001-KEY.N by the client 120 and the remote server 130: a round robin process 210, an exemplary embodiment of which is discussed in FIGS. 3, 4A and 4B and accompanying text; a fixed link sequential process 220, an exemplary embodiment of which is discussed in FIGS. 3, 5A and 5B and accompanying text; and an incremented sequential process 230, an exemplary embodiment of which is discussed in FIGS. 6, 7A and 7B. The following description of FIG. 2 includes all possible methods by which the client 120 may query the remote server 130, and all possible methods by which the server 130 may transmit software keys KEY.001-KEY.N and software records REC.001-REC.N. The methods are discussed in further detail in subsequent Figures and their accompanying descriptions. In step 2.02 the client 120 specifies initial and final date time stamp query boundaries, wherein a first date time stamp T.sub.0 represents the beginning bound of a first query QRY.001, and a second date time stamp T.sub.N represents the ending bound of the first query QRY.001. In step 2.04 the client 120 submits the first query QRY.001 for the software keys KEY.001-KEY.N within date time stamp boundaries T.sub.0-T.sub.N specified in step 2.02 to the remote server 130. In step 2.06 the client 120 receives the specified software keys KEY.001-KEY.N from the remote server 130. In step 2.08 the client 120 writes the keys KEY.001-KEY.N to separate query files QRF.001-QRF.N within the client memory 120G, the number of separate query files QRF.001-QRF.N dependent on a designated number of subtasks. The number of subtasks may optionally be delineated based upon a plurality of factors, including, but not limited to, the computing capacity of the client 120 and/or the remote server 130. In step 2.10 the client 120 initiates and runs a plurality of parallel and distinct replication jobs REPL.001-REPL.N for each of the distinctly specified subtasks using the software keys KEY.001-KEY.N. In step 2.12 the client 120 determines whether the replication processes REPL.001-REPL.N have been completed for all of the designated subtasks. When the client 120 determines in step 2.12 that the replication processes REPL.001-REPL.N are not complete, the client 120 proceeds to step 2.14, wherein the client 120 waits for the replication processes REPL.001-REPL.N to be completed. The client 120 subsequently returns to step 2.12. Alternatively, when the determination in step 2.12 is positive, i.e. when the client 120 determines that all of the replication processes REPL.001-REPL.N are complete, the client 120 determines in step 2.16 whether the replication processes REPL.001-REPL.N were executed successfully. When the determination in step 2.16 is positive, the client 120 advances to step 2.22 wherein the client 120 determines whether more tables and/or objects are present which need replication. In the alternative, when the determination in step 2.16 is negative, the client 120 advances to step 2.18, wherein the client 120 determines whether to notify the remote server 130 of the failure of the replication processes REPL.001-REPL.N. When the determination to notify the remote server 130 is negative, the client 120 advances to step 2.22. Alternatively, when the determination in step 2.18 is positive, the client 120 notifies the remote server 130 of the failure of the replication processes REPL.001-REPL.N in step 2.20. In step 2.22 the client 120 determines whether more tables and/or objects are present which need replication. When the determination in step 2.22 is positive, the client 120 returns to step 2.02 and re-executes the loop of steps 2.02 through 2.22 as necessary. Alternatively, when the determination in step 2.22 is positive, the client 120 advances to step 2.24 wherein the client 120 determines again whether the replication processes REPL.001-REPL.N were successful. When the determination in step 2.24 is negative, the client 120 advances to step 2.26, wherein the client 120 notifies the server 130 of the failure of the replication processes REPL.001-REPL.N. The client 120 proceeds either from step 2.26 or from step 2.20 to step 2.28, wherein confirmation of the failure notification FL.MSG.001-FL.MSG.N is received from the remote server 130. The client 120 may proceed either from a positive determination in step 2.24 or from successful execution of step 2.28 to step 2.30, wherein alternate processes are executed.

Referring now generally to the Figures, and particularly to FIG. 3, FIG. 3 is a flowchart of a further aspect of the invented method whereby the remote server 130 takes part in an exemplary embodiment of a round robin process 210 and/or of a fixed sequential replication process 220. In step 3.02 the remote server 130 generates a plurality of software keys KEY.001-KEY.N. In step 3.04 the remote server 130 determines whether a query QRY.001 has been received for the generated software keys KEY.001-KEY.N. When the determination in step 3.04 is negative, the remote server 130 proceeds to step 3.20, wherein the server 130 executes alternate processes. In the alternative, when the determination in step 3.04 is positive, the remote server 130 advances to step 3.06, wherein the remote server 130 transmits the software keys KEY.001-KEY.N to the client 120. In step 3.08 the remote server 130 receives uniquely populated replication process requests REQ.001-REQ.N containing one or more software keys KEY.001-KEY.N. The remote server 130 determines, in step 3.10, whether to engage in the requested replication processes REPL.001-REPL.N. When the determination in step 3.10 is negative, the remote server 130 proceeds to step 3.20, wherein alternate processes are executed. Alternatively, when the determination in step 3.10 is positive, the remote server 130 transmits the requested records REC.001-REC.N associated with the software keys KEY.001-KEY.N to the client 120. In step 3.14 the remote server 130 determines whether the replication processes REPL.001-REPL.N were successful. When the determination in step 3.14 is negative, the remote server 130 proceeds to step 3.02. Alternatively, when the determination in step 3.14 is positive, the remote server 130 transmits a success message SCS.MSG.001-SCS.MSG.N to the client 120 in step 3.16. In step 3.18, the remote server 130 determines whether more tables and/or objects are present for replication. When the determination in step 3.18 is negative, the remote server 130 advances to step 3.20, wherein alternate processes are executed. In the alternative, when the determination in step 3.18 is positive, the remote server 130 proceeds to step 3.02, and re-executes the loop of steps 3.02 through 3.18 as necessary.

Referring now generally to the Figures and particularly to FIG. 4A, FIG. 4A is a flowchart of an aspect of the invented method whereby the client 120 queries the remote server 130 for a plurality of software keys KEY.001-KEY.N between time bounds designated in step 4.02. In step 4.02 the client 120 specifies initial and final date time stamp query boundaries, wherein a first date time stamp T.sub.0 represents the beginning bound of a first query QRY.001, and a second date time stamp T.sub.N represents the ending bound of the first query QRY.001. In step 4.04 the client 120 determines a maximum possible number of download threads THR.001-THR.N, represented herein by the letter “M.” In step 4.05 the client 120 designates a number “N” of query files QRF.001-QRF.N into which the requested software keys KEY.001-KEY.N may be written, and sets the maximum number of threads M equal to the number of query files QRF.001-QRF.N N. In step 4.06 the client 120 submits the first query QRY.001 for the software keys KEY.001-KEY.N within date time stamp boundaries T.sub.0-T.sub.N specified in step 4.02 to the remote server 130. The client 120 subsequently advances to step 4.08 of FIG. 4B.

Referring now generally to the Figures, and particularly to FIG. 4B, FIG. 4B is a flowchart of an aspect of the invented method whereby the client 120 populates N number of query files QRF.001-QRF.N with software keys KEY.001-KEY.N transmitted by the remote server 130, and downloads the software records REC.001-REC.N using M threads THR.001-THR.N. The client 120 proceeds from step 4.06 of FIG. 4A to step 4.08, wherein the client 120 receives a first software key KEY.001 from the remote server 130. In step 4.10 the client 120 writes the first key KEY.001 to the next available query file QRF.001-QRF.N in a round robin fashion. The round robin process 210 involves writing one software key KEY.001 to one query file QRF.001, a second software key KEY.002 to a second query file QRF.002, continuing assigning one key KEY.001-KEY.N to one query file QRF.001-QRF.N until a key KEY.001-KEY.N has been assigned to a designated final query file QRF.N. The client 120 subsequently determines in step 4.12 whether more software keys KEY.001-KEY.N are available for transfer from the remote server 130. When the determination in step 4.12 is positive, the client returns to step 4.08 and re-executes the loop of steps 4.08 through 4.12 until the determination in step 4.12 is negative. When the determination in step 4.12 is negative, the client 120 requests the software records REC.001-REC.N associated with the software keys KEY.001-KEY.N from the server 130 in step 4.14. In step 4.16 the client 120 simultaneously downloads the software records REC.001-REC.N associated with the software keys KEY.001-KEY.N which have been written to N query files QRF.001-QRF.N in M number of parallel download threads THR.001-THR.N.

In step 4.18 the client 120 determines whether the replication of the software records REC.001-REC.N was successful. When the determination in step 4.18 is negative, the client 120 determines whether to notify the remote server 130 of the failed replication REPL.001-REPL.N. When the client 120 determines in step 4.20 to notify the remote server 130 of the failure, the client 120 notifies the remote server 130 of the failure in step 4.22. Alternatively, when the determination in step 4.18 is positive, the client 120 advances to step 4.24, wherein the client 120 determines whether more tables or objects are present for replication. When the determination in step 4.24 is positive, the client 120 returns to step 4.02 of FIG. 4A. Alternatively, when the determination in step 4.24 is negative, the client 120 determines in step 4.26 whether the replication was successful. When the determination in step 4.26 is negative, the client 120 notifies the remote server 130 of the failure. The client 120 proceeds either from step 4.22 or from step 4.28 to step 4.30, wherein the client 120 receives confirmation of the failure notification FL.MSG.001-FL.MSG.N from the remote server 130. The client 120 subsequently proceeds either from the execution of step 4.30, or from a positive determination in step 4.26 to step 4.32, wherein the client 120 executes alternate processes.

Referring now generally to the Figures, and particularly to FIG. 5A, FIG. 5A is a flowchart of an additional embodiment of the invented method whereby the client 120 transmits a query QRY.001 for an example embodiment of a fix-link sequential process 220. In step 5.02 the client 120 specifies initial and final date time stamp query boundaries, wherein a first date time stamp T.sub.0 represents the beginning bound of a first query QRY.001, and a second date time stamp T.sub.N represents the ending bound of the first query QRY.001. In step 5.04 the client 120 determines a maximum possible number of download threads THR.001-THR.N, represented herein by the letter “M.” In step 5.06 the client 120 submits the first query QRY.001 for the software keys KEY.001-KEY.N within date time stamp boundaries T.sub.0-T.sub.N specified in step 5.02 to the remote server 130. The client 120 subsequently advances to step 5.08 of FIG. 5B.

Referring now generally to the Figures, and particularly to FIG. 5B, FIG. 5B is a flowchart of an additional embodiment of the invented method whereby the client 120 writes the software keys KEY.001-KEY.N to the query files QRF.001-QRF.N, and downloads the software records REC.001-REC.N associated with the software keys KEY.001-KEY.N in a series of parallel download threads THR.001-THR.N. In step 5.08 the client 120 opens a first fixed-length query file FIX.QRF.001. The fixed-length query files FIX.QRF.001-FIX.QRF.N may contain a previously designated maximum number of software keys KEY.001-KEY.N. In step 5.10 the client 120 determines whether a new software key KEY.001-KEY.N has been received. When the determination in step 5.10 is negative, the client 120 returns to step 5.02 of FIG. 5A. Alternatively, when the determination in step 5.10 is positive, the client 120 determines in step 5.12 whether the current number of software keys KEY.001-KEY.N contained in the currently open fixed-length query file FIX.QRF.001-FIX.QRF.N contains more than the designated maximum number of software keys KEY.001-KEY.N. When the determination in step 5.12 is positive, the client 120 returns to step 5.08 and opens a new fixed-length query file FIX.QRF.001-FIX.QRF.N. Alternatively, when the determination in step 5.12 is negative, the client 120 writes the new software key KEY.001-KEY.N to the open fixed-length query file FIX.QRF.001-FIX.QRF.N. In step 5.16 the client 120 determines whether more fixed-length query files FIX.QRF.001-FIX.QRF.N are present into which software keys KEY.001-KEY.N may be written are present. When the client 120 determines in step 5.16 that more fixed-length query files FIX.QRF.001-FIX.QRF.N are present, the client 120 returns to step 5.08, wherein the client 120 opens a new fixed-length query file FIX.QRF.001-FIX.QRF.N. In the alternative, when the client 120 determines that each of the possible fixed-length query files FIX.QRF.001-FIX.QRF.N contain the maximum number of software keys KEY.001-KEY.N, the client 120 determines in step 5.18 whether more software keys KEY.001-KEY.N are available for writing from the server 130. When the determination in step 5.18 is positive, the client 120 proceeds to step 5.10, wherein the client 120 repeats the loop of steps 5.10 through 5.18 until the determination in step 5.18 is negative. When the determination in step 5.18 is negative, the client 120 proceeds to step 5.20, wherein the client 120 executes a parallel download of the software records REC.001-REC.N associated with the software keys KEY.001-KEY.N in the fixed-length query files FIX.QRF.001-FIX.QRF.N in a series of download threads THR.001-THR.N up to the designated maximum number of download threads THR.001-THR.N. A number of query files QRF.001-QRF.N may exist than the maximum number of download threads THR.001-THR.N M. Accordingly, the parallel download of step 5.20 may include only the maximum number M of download threads THR.001-THR.N, but once a single download thread THR.001 has completed the replication of all of the software records REC.001-REC.N associated with the software keys KEY.001-KEY.N, a subsequent download thread THR.001 may begin. Thus, in step 5.22 the client 120 determines whether one download thread THR.001-THR.N has completed its download. When the determination in step 5.22 is negative, the client 120 waits for a download thread THR.001-THR.N to be complete in step 5.24. The client 120 subsequently repeats the loop of steps 5.22 through 5.24 until the determination in step 5.22 is positive. When the determination in step 5.22 is positive, the client 120 advances to step 5.26, wherein the client 120 determines whether more key-containing fixed-length query files FIX.QRF.001-FIX.QRF.N are present for threaded download. When the determination in step 5.26 is positive, the client 120 returns to step 5.20 wherein the client 120 executes a further parallel download of the software records REC.001-REC.N associated with the software keys KEY.001-KEY.N in the fixed-length query files FIX.QRF.001-FIX.QRF.N in a series of download threads THR.001-THR.N up to the designated maximum number of download threads THR.001-THR.N. Alternatively, when the determination in step 5.26 is negative, the client 120, in step 5.28 determines whether the replication of the software records REC.001-REC.N was successful. When the determination in step 5.26 is negative, the client 120 determines whether to notify the remote server 130 of the failed replication REPL.001-REPL.N. When the client 120 determines in step 5.28 to notify the remote server 130 of the failure, the client 120 notifies the remote server 130 of the failure in step 5.32. Alternatively, when the determination in step 5.28 is positive, the client 120 advances to step 5.34, wherein the client 120 determines whether more tables or objects are present for replication. When the determination in step 5.34 is positive, the client 120 returns to step 5.02 of FIG. 5A. Alternatively, when the determination in step 5.34 is negative, the client 120 determines in step 5.36 whether the replication was successful. When the determination in step 5.36 is negative, the client 120 notifies the remote server 130 of the failure in step 5.38. The client 120 proceeds either from step 5.32 or from step 5.38 to step 5.40, wherein the client 120 receives confirmation of the failure notification FL.MSG.001-FL.MSG.N from the remote server 130. The client 120 subsequently proceeds either from the execution of step 5.40, or from a positive determination in step 5.36 to step 5.42, wherein the client 120 executes alternate processes.

Referring now generally to the Figures, and particularly to FIG. 6, FIG. 6 is a flowchart of an additional aspect of the invented method whereby the remote server 130 takes part in exemplary embodiment of an incremented sequential process 230. In step 6.02 the remote server 130 generates a plurality of software keys KEY.001-KEY.N. In step 6.04 the remote server 130 determines whether a key number query KEY.NUM.REQ.001-KEY.NUM.REQ.N for the number of software keys KEY.001-KEY.N within a given time limit T.sub.0-T.sub.N has been received. When the determination in step 6.04 is negative, the remote server 130 executes alternate processes in step 6.24. Alternatively, when the determination in step 6.04 is positive, the remote server 130 transmits the number of keys KEY.001-KEY.N within the designated time limit T.sub.0-T.sub.N to the client 120. In step 6.08 the remote server 130 determines whether a query QRY.001 has been received for the generated software keys KEY.001-KEY.N. When the determination in step 6.08 is negative, the remote server 130 proceeds to step 6.24, wherein the server 130 executes alternate processes. In the alternative, when the determination in step 6.08 is positive, the remote server 130 advances to step 6.10, wherein the remote server 130 transmits the software keys KEY.001-KEY.N to the client 120. In step 6.12 the remote server 130 receives uniquely populated replication process requests REQ.001-REQ.N containing one or more software keys KEY.001-KEY.N. The remote server 130 determines, in step 6.14, whether to engage in the requested replication processes REPL.001-REPL.N. When the determination in step 6.14 is negative, the remote server 130 proceeds to step 6.24, wherein alternate processes are executed. Alternatively, when the determination in step 6.14 is positive, the remote server 130 transmits the requested records REC.001-REC.N associated with the software keys KEY.001-KEY.N to the client 120. In step 6.18 the remote server 130 determines whether the replication processes REPL.001-REPL.N were successful. When the determination in step 6.18 is negative, the remote server 130 proceeds to step 6.22. Alternatively, when the determination in step 6.18 is positive, the remote server 130 transmits a success message SCS.MSG.001-SCS.MSG.N to the client 120 in step 6.20. In step 6.22, the remote server 130 determines whether more tables and/or objects are present for replication. When the determination in step 6.22 is negative, the remote server 130 advances to step 6.24, wherein alternate processes are executed. In the alternative, when the determination in step 6.22 is positive, the remote server 130 proceeds to step 6.02, and re-executes the loop of steps 6.02 through 6.24 as necessary.

Referring now generally to the Figures, and particularly to FIG. 7A, FIG. 7A is a flowchart of a further embodiment of the invented method wherein the client 120 transmits a series of queries QRY.001-QRY.N in an exemplary embodiment of an incremented sequential download process 230. In step 7.02 the client 120 specifies initial and final date time stamp query boundaries, wherein a first date time stamp T.sub.0 represents the beginning bound of a first query QRY.001, and a second date time stamp T.sub.N represents the ending bound of the first query QRY.001. In step 7.04 the client 120 determines a maximum possible number of download threads THR.001-THR.N, represented herein by the letter “M.” In step 7.06 the client 120 designates a number “N” of query files QRF.001-QRF.N into which the requested software keys KEY.001-KEY.N may be written, and sets the maximum number of threads M equal to the number of query files QRF.001-QRF.N N. In step 7.08 the client 120 submits a query QRY.001 to the remote server 130 for the number of software keys KEY.001-KEY.N within the designated time limit T.sub.0-T.sub.N. In step 7.10 the client 120 receives, in a series of parallel downloads, the number of software keys KEY.001-KEY.N from the remote server 130. In step 7.12 the client divides the maximum number of download threads THR.001-THR.N M into the number of software keys received from the remote server 130 to generate the maximum number of software keys KEY.001-KEY.N per query file QRF.001-QRF.N. The number of software keys KEY.001-KEY.N per query file QRF.001-QRF.N is optimally equal, but the final query file QRF.N may contain one query file less than previous query files QRF.001-QRF.N, depending on the total number of query files QRF.001-QRF.N and the total number of software keys KEY.001-KEY.N. In step 7.14 the submits a query QRY.001-QRY.N to the remote server 130 for the software keys KEY.001-KEY.N within the chosen time boundaries. The client 120 advances to step 7.16 of FIG. 7B.

Referring now generally to the Figures, and particularly to FIG. 7B, FIG. 7B is a flowchart of an embodiment of the invented method wherein the client 120 writes software keys KEY.001-KEY.N to query files QRF.001-QRF.N and subsequently downloads the software records REC.001-REC.N associated with the software keys KEY.001-KEY.N written to the query files QRF.001-QRF.N in a threaded download scheme. In step 7.18 the client 120 initializes a query file counter 700 and sets the query file counter 700 to zero. In step 7.20 the client 120 receives the first software key KEY.001 from the remote server 130. In step 7.22 the client 120 writes the received software key KEY.001 to the first open query file QRF.001. In step 7.24 the client 120 determines whether the first sequential query file QRF.001 is loaded with the maximum number of software keys KEY.001-KEY.N as determined in step 7.14 of FIG. 7A. When the determination in step 7.26 is negative, the client 120 returns to step 7.20 and re-executes the loop of steps 7.20 through 7.24 until the determination in step 7.24 is positive. When the determination in step 7.24 is positive, the client 120 opens the subsequent query file QRF.002 and increment the query file counter 700 in step 7.26. In step 7.28 the client 120 determines whether the final key KEY.N has been received from the remote server 130. When the determination in step 7.28 is negative, the client 120 repeats the loop of steps 7.20 through 7.28 as necessary. In the alternative, when the client 120 determines in step 7.28 that the final key KEY.N has been received from the remote server 130, the client 120 advances to step 7.30. In step 7.30 executes a sequential, threaded download of the software records REC.001-REC.N associated with the software keys KEY.001-KEY.N.

In step 7.32 the client 120 determines whether the replication of the software records REC.001-REC.N was successful. When the determination in step 7.32 is negative, the client 120 determines in step 7.34 whether to notify the remote server 130 of the failed replication REPL.001-REPL.N. When the client 120 determines in step 7.34 to notify the remote server 130 of the failure, the client 120 notifies the remote server 130 of the failure in step 7.36. Alternatively, when the determination in step 7.32 is positive, the client 120 advances to step 7.38, wherein the client 120 determines whether more tables or objects are present for replication. When the determination in step 7.38 is positive, the client 120 returns to step 7.02 of FIG. 7A. Alternatively, when the determination in step 7.38 is negative, the client 120 determines in step 7.40 whether the replication was successful. When the determination in step 7.40 is negative, the client 120 notifies the remote server 130 of the failure in step 7.42. The client 120 proceeds either from step 7.36 or from step 7.42 to step 7.44, wherein the client 120 receives confirmation of the failure notification FL.MSG.001-FL.MSG.N from the remote server 130. The client 120 subsequently proceeds either from the execution of step 7.44, or from a positive determination in step 7.40 to step 7.46, wherein the client 120 executes alternate processes.

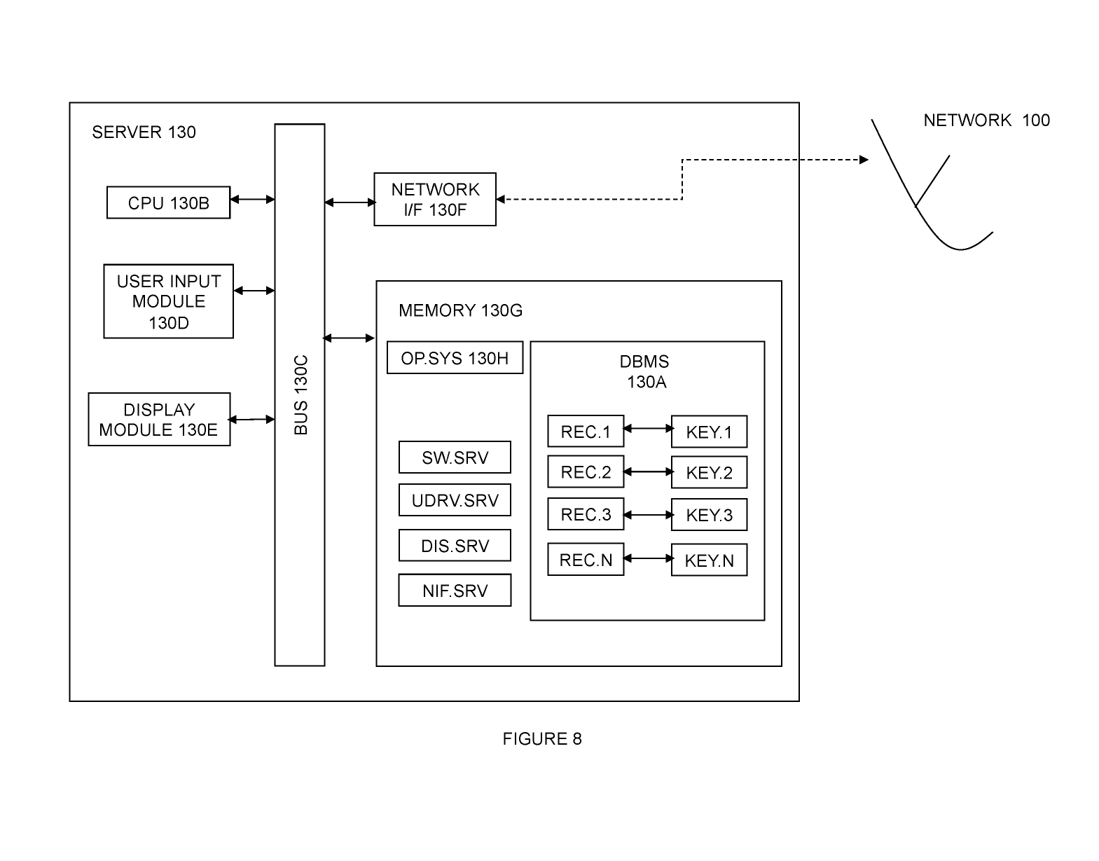

Referring now generally to the Figures, and particularly to FIG. 8, FIG. 8 is a block diagram of the remote server 130 of the network 100 of FIG. 1, wherein the remote server 130 comprises: a central processing unit (“CPU”) 130B; a user input module 130D; a display module 130E; a software bus 130C bidirectionally communicatively coupled with the CPU 130B, the user input module 130D, the display module 130E; the software bus 130C is further bidirectionally coupled with a network interface 130F, enabling communication with alternate computing devices by means of the electronic communications network 100, and a memory 130G. The software bus 130C facilitates communications between the above-mentioned components of the server 130. The memory 130G of the remote server 130 includes a software operating system OP.SYS 130H. The software OP.SYS 130H of the remote server 130 may be selected from freely available, open source and/or commercially available operating system software, to include but not limited to a LINUX™ or UNIX™ or derivative operating system, such as the DEBIAN™ operating system software as provided by Software in the Public Interest, Inc. of Indianapolis, Ind.; a WINDOWS XP™ or WINDOWS 8™ operating system as marketed by Microsoft Corporation of Redmond, Wash.; or the MAC OS X operating system or iPhone G4 OS™ as marketed by Apple, Inc. of Cupertino, Calif.

The remote server memory 130G further includes a server software SW.SRV, a server user input driver UDRV.SRV, a server display driver DIS.SRV, and a server network interface drive NIF.SRV. Within a server DBMS 130A are a plurality of software records REC.001, REC.002, REC.003, and REC.N. Each of the plurality of software records REC.001-REC.N within the server DBMS 130 are paired with one of a plurality of keys: KEY.001, KEY.002, KEY.003, and KEY.N, respectively. The software records REC.001-REC.N may be associated with the keys KEY.001-KEY.N for the purpose of facilitating cataloguing, searching, and modifying the software records REC.001-REC.N. The server software SW.SRV enables the server 130 to perform the aspects of the invented method as disclosed herein, and particularly at the methods of FIGS. 3, 6 and 19.

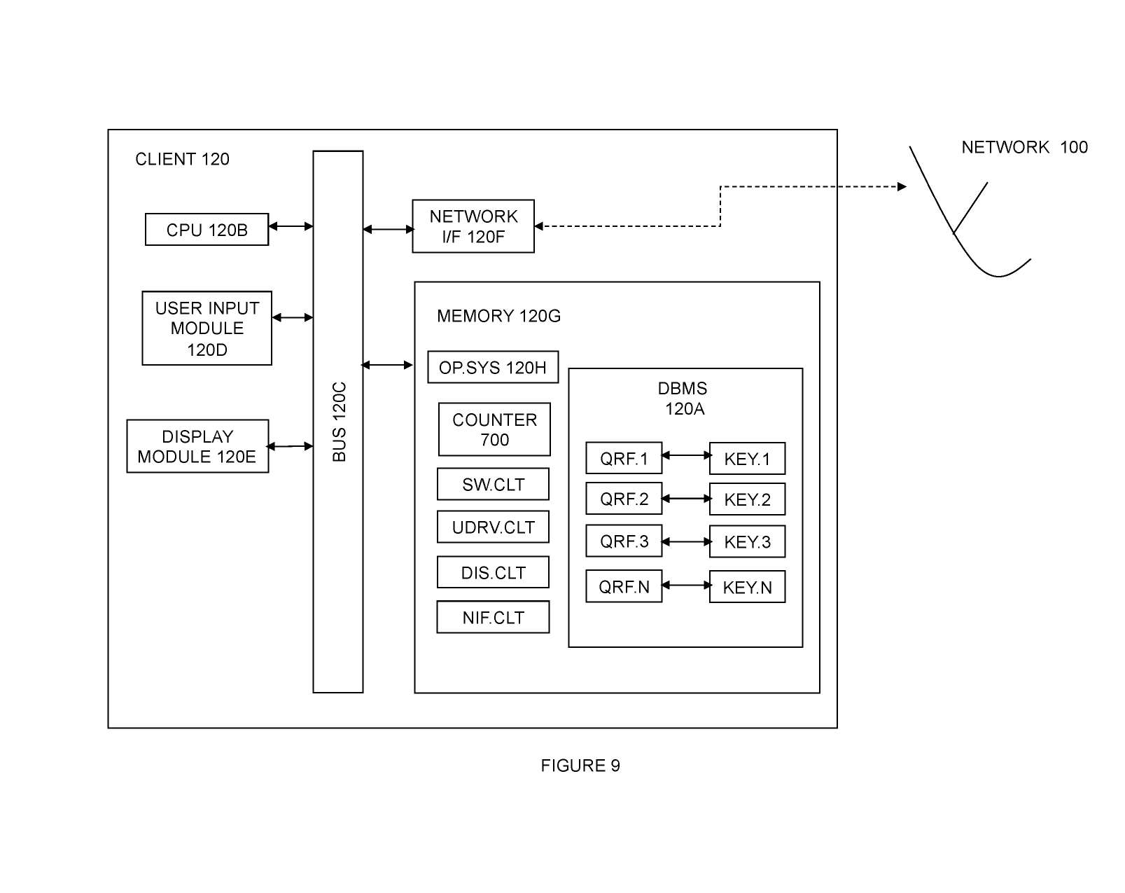

Referring now generally to the Figures, and particularly to FIG. 9, FIG. 9 is a block diagram of the client 120 of the network 100 of FIG. 1, wherein the client 120 comprises: a central processing unit (“CPU”) 120B; a user input module 120D; a display module 120E; a software bus 120C bidirectionally communicatively coupled with the CPU 120B, the user input module 120D, the display module 120E; the software bus 120C is further bidirectionally coupled with a network interface 120F, enabling communication with alternate computing devices by means of the electronic communications network 100; and a memory 120G. The software bus 120C facilitates communications between the above-mentioned components of the client 120. The memory 120G of the client 120 includes a client software operating system OP.SYS 120H. The software OP.SYS 120H of the client 120 may be selected from freely available, open source and/or commercially available operating system software, to include but not limited to a LINUX™ or UNIX™ or derivative operating system, such as the DEBIAN™ operating system software as provided by Software in the Public Interest, Inc. of Indianapolis, Ind.; a WINDOWS XP™, VISTA™ or WINDOWS 7™ operating system as marketed by Microsoft Corporation of Redmond, Wash.; or the MAC OS X operating system or iPhone G4 OS™ as marketed by Apple, Inc. of Cupertino, Calif.

The memory 130G further includes a client software SW.CLT, the counter 700 of FIG. 7B, a client user input driver UDRV.CLT, a client display driver DIS.CLT, and a client network interface drive NIF.CLT. Within the client DBMS 120A are a plurality of query files QRF.001, QRF.002, QRF.003, and QRF.N. Each of the plurality of query files QRF.001-QRF.N within the server DBMS 130 are paired with one of a plurality of keys: KEY.001, KEY.002, KEY.003, and KEY.N, respectively. The association of the query files QRF.001-QRF.N with the keys KEY.001-KEY.N allows for ease of cataloguing, retrieval, and modification of the query files QRF.001-QRF.N. The client software SW.CLT enables the CLIENT 120 to perform the aspects of the invented method as disclosed herein, and particularly at the methods of FIGS. 2, 4A, 4B, 5A, 5B, 7A, 7B, and 18.

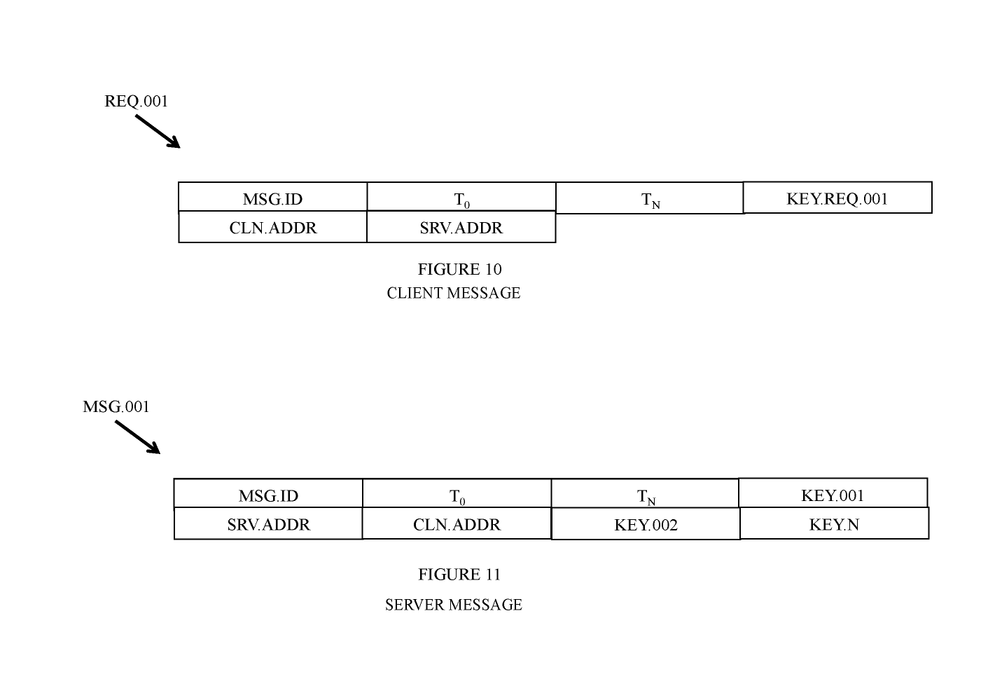

Referring now generally to the Figures and particularly to FIG. 10, FIG. 10 is a block diagram of a first query message REQ.001 transmitted from the client 120 to the remote server 130. The first query message REQ.001 includes: (a.) a unique message identifier, such that the client 120 and the remote server 130 may appropriately identify and respond to the message; (b.) a first date time stamp T.sub.0, as a beginning time boundary for the query; (c.) a second date time stamp T.sub.N, as an ending time boundary for the query; (d.) a first key request KEY.REQ.001 for the software keys KEY.001-KEY.N within the designated time boundaries; (e.) the address of the client 120 CLN.ADDR as the sending address; and (f.) the address of the remote server 130 SRV.ADDR as the recipient address.

Referring now generally to the Figures, and particularly to FIG. 11, FIG. 11 is a block diagram of a first key containing message MSG.001 transmitted from the remote server 130 to the client 120. The first key containing message MSG.001 includes: (a.) a unique message identifier, such that the client 120 and the remote server 130 may appropriately identify and respond to the message; (b.) a first date time stamp T.sub.0, as a beginning time boundary for the query; (c.) a second date time stamp T.sub.N, as an ending time boundary for the query; (d.) a plurality of software keys KEY.001-KEY.N; (e.) the address of the remote server 130 SRV.ADDR as the sending address; and (f.) the address of the client 120 CLN.ADDR as the recipient address.

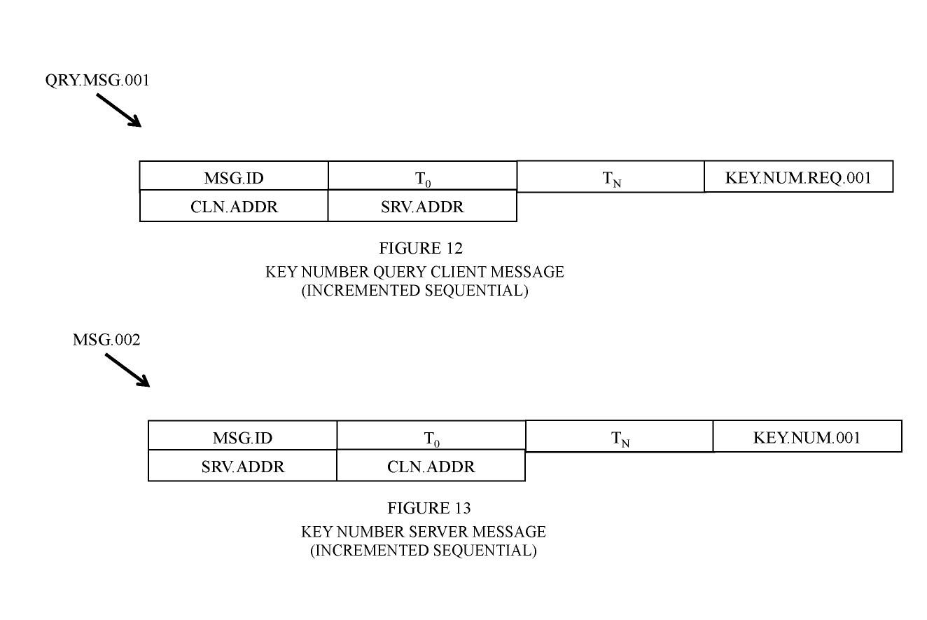

Referring now generally to the Figures, and particularly to FIG. 12, FIG. 12 is a block diagram of an exemplary first key number query message QRY.MSG.001 transmitted from the client 120 to the server 130. The first key number query message QRY.MSG.001 includes: (a.) a unique message identifier, such that the client 120 and the remote server 130 may appropriately identify and respond to the message; (b.) a first date time stamp T.sub.0, as a beginning time boundary for the query; (c.) a second date time stamp T.sub.N, as an ending time boundary for the query; (d.) a first key number request KEY.NUM.REQ.001 for the software keys KEY.001-KEY.N within the designated time boundaries; (e.) the address of the client 120 CLN.ADDR as the sending address; and (f.) the address of the remote server 130 SRV.ADDR as the recipient address.

Referring now generally to the Figures and particularly to FIG. 13, FIG. 13 is a block diagram of an exemplary first key number containing message MSG.002, transmitted from the remote server 130 to the client 120. The first key number containing message MSG.002 includes: (a.) a unique message identifier MSG.ID, such that the client 120 and the remote server 130 may appropriately identify and respond to the message; (b.) a first date time stamp T.sub.0, as a beginning time boundary for the query; (c.) a second date time stamp T.sub.N, as an ending time boundary for the query; (d.) a number of keys KEY.NUM.001; (e.) the address of the remote server 130 SRV.ADDR as the sending address; and (f.) the address of the client 120 CLN.ADDR as the recipient address.

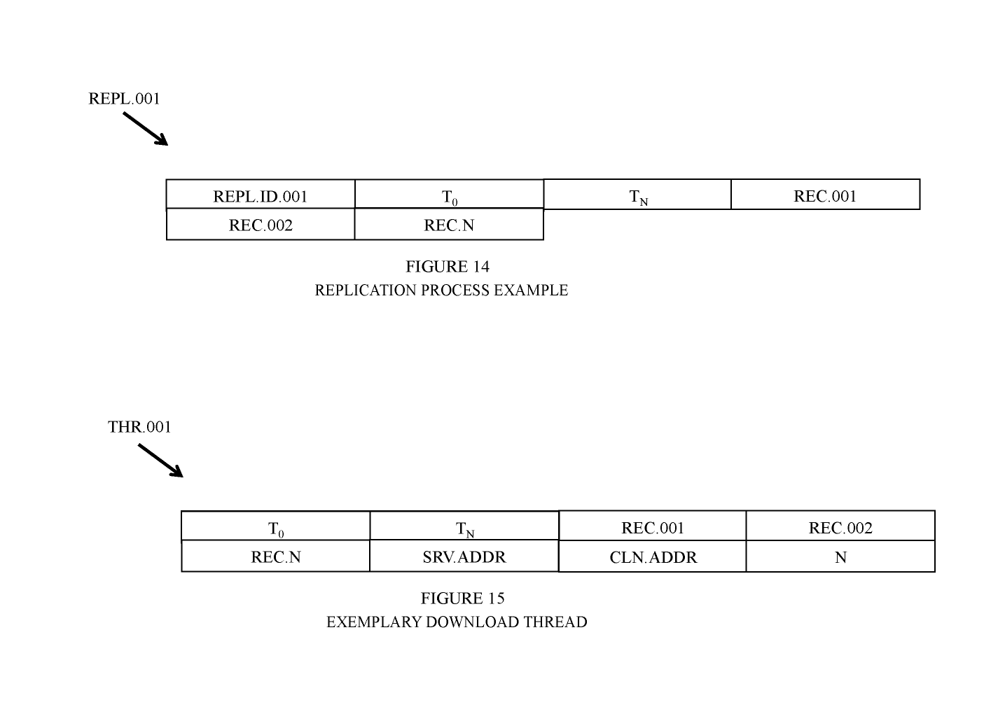

Referring now generally to the Figures and particularly to FIG. 14, FIG. 14 is a block diagram of an exemplary first replication process REPL.001. The first replication process REPL.001 includes: (a.) a unique replication process identifier REPLID.001, such that the client 120 and the remote server 130 may appropriately identify and respond to the message; (b.) a first date time stamp T.sub.0, as a beginning time boundary for the query; (c.) a second date time stamp T.sub.N, as an ending time boundary for the query; and (d.) a plurality of software records REC.001-REC.N.

Referring now generally to the Figures and particularly to FIG. 15, FIG. 15 is a block diagram of an exemplary first download thread THR.001. The first download thread THR001 includes: (a.) a first date time stamp T.sub.0, as a beginning time boundary for the query; (b.) a second date time stamp T.sub.N, as an ending time boundary for the query; (c.) a plurality of software records REC.001-REC.N; (d.) the address of the remote server 130 SRV.ADDR as the sending address; (e.) the address of the client 120 CLN.ADDR as the recipient address; and (f.) the number N of maximum number of records REC.001-REC.N per thread THR.001.

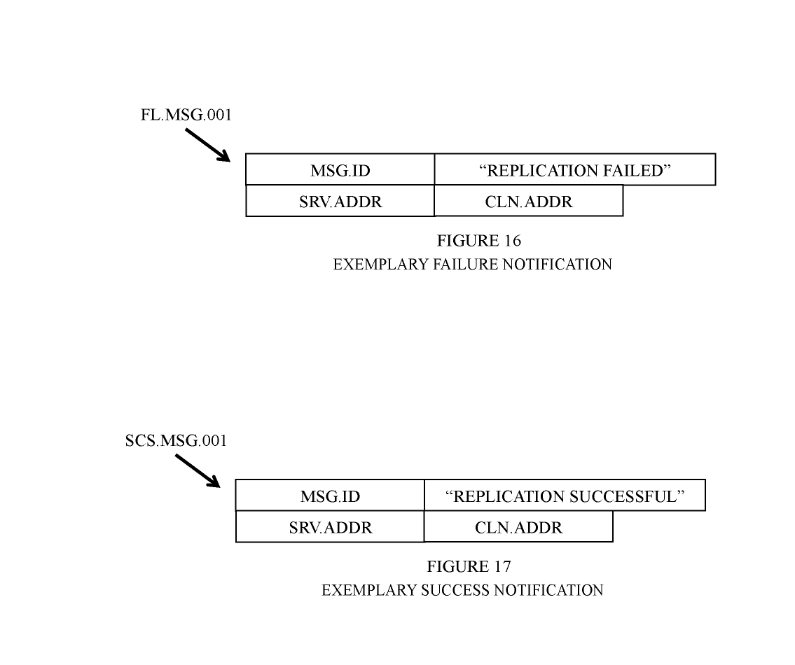

Referring now generally to the Figures and particularly to FIG. 16, FIG. 16 is a block diagram of an exemplary first failure notification FL.MSG.001. The first failure notification FL.MSG.001 includes: (a.) a unique failure message FL.MSG.001 identifier MSG.001, such that the client 120 and the remote server 130 may appropriately identify and respond to the failure message FL.MSG.001 (b.) a string of text or other communicative means indicating the failure of the replication process REPL.001-REPL.N; (c.) the address of the remote server 130 SRV.ADDR as the sending address; and (D.) and the address of the client 120 CLN.ADDR as the recipient address.

Referring now generally to the Figures and particularly to FIG. 17, FIG. 17 is a block diagram of an exemplary first success notification SCS.MSG.001. The first success notification SCS.MSG.001 includes: (a.) a unique success message SCS.MSG.001 identifier MSG.001, such that the client 120 and the remote server 130 may appropriately identify and respond to the success message SCS.MSG.001 (b.) a string of text or other communicative means indicating the success of the replication process REPL.001-REPL.N; (c.) the address of the remote server 130 SRV.ADDR as the sending address; and (D.) and the address of the client 120 CLN.ADDR as the recipient address.

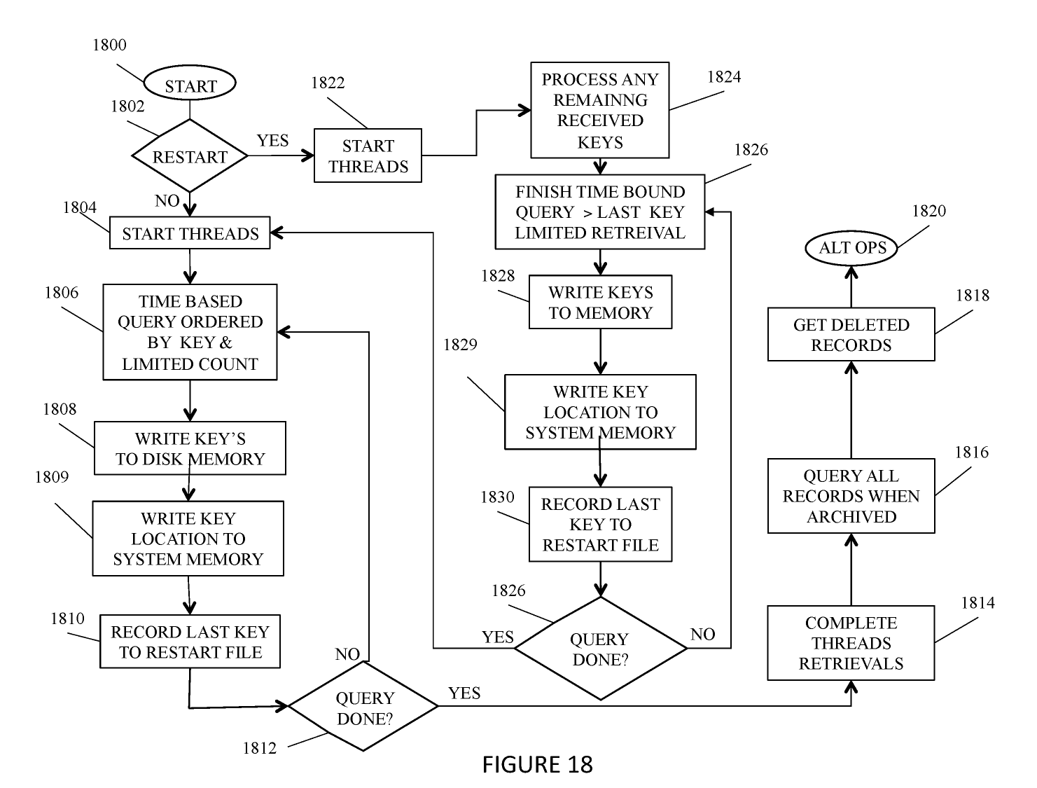

Referring now generally to the Figures and particularly to FIG. 18, FIG. 18 is a flowchart of an alternate preferred embodiment of the invented method wherein the client 120 requests primary keys KEY.1-KEY.N of records REC.1-REC.N that have been updated within a specified time bounds and optionally requesting limited quantities of record keys KEY.1-KEY.N in one or more server response messages from the remote server 130. In step 1800 the client 120 is powered up and proceeds to determine in step 1802 whether itself, the client 120, is in a restart condition regarding the requesting of primary record keys KEY.1-KEY.N of the method of FIG. 18. When the client 120 determines that itself is not in a restart condition in step 1802 the client 120 proceeds on to perform step 1804. In step 1804 the client starts a pre-specified number of N threads that operate to request record updates from the remote server 130 that are identified by primary keys KEY.1-KEY.N received by the client in one or more iterations of step 1808 and optionally step 1828.

The client 120 proceeds from step 1804 to step 120 generates and transmits an exemplary key request message KREQ.001, as further discussed in reference to FIG. 10, via the network 100 and to the remote server 130. The exemplary key request message KREQ.001 may optionally include an exemplary first count value KCNT.001 that numerically specifies a total key count limitation to be imposed by the remote server 130 in responding to the exemplary key request message KREQ.001 whereby the remote server 130 is directed to limit a total count of primary keys KEY.1-KEY.N to be provided to the client 120 in response to the exemplary key request message KREQ.001. The exemplary key request message KREQ.001 specifies time bounds of update time-date data to be applied by the remote serve 130 in selecting primary keys KEY.1-KEY.N to be sent in response to receipt of the exemplary key request message KREQ.001. The exemplary key request message KREQ.001 may optionally further include a specific value of a primary key KEY.1-KEY.N that the remote server 130 is directed to apply to select only primary key numbers KEY.1-KEY.N that are in value sequentially beyond the value of primary key value KEY.1-KEY.N provided in the exemplary key request message KREQ.01.

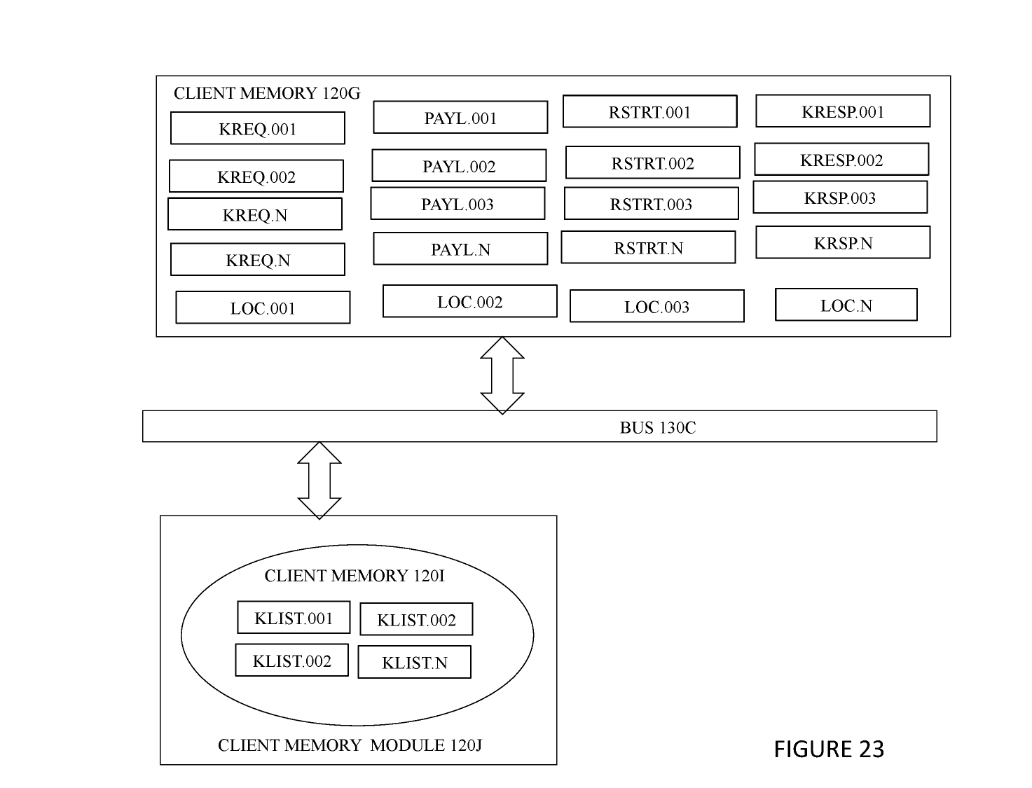

In step 1808 the client 120 receives an exemplary key response message KRESP.001 and stores the primary keys KEY.1-KEY.N harvested from the exemplary key response message KRESP.001 to a client disk memory 1201 of a client disk memory module 120J of the client 120, as shown on FIG. 23 for access by a designated thread as started in step 1804. It is understood that the records REC.1-REC.N referenced by the primary keys KEY.1-KEY.N may optionally be accessed to the threads of the method of FIG. 18 by the client 120 from the remote server 130 and/or optionally other locations or sources accessible to the client 120 via the network 100.

In step 1809 the client 120 records, and make accessible to the record update retrieving threads of the method of FIG. 18, location data and/or pathway data LOC.001-LOC.N that is applied by the client 120 to enable these threads to find and store the primary keys KEY.1-KEY.N harvested from the exemplary key response messages KRESP.001-KRESP.N for application in retrieving record update information from the remote server 130 and/or from resources accessible via the network 100, as executed at least in steps 1804 and 1814.

In step 1810 the client 120 stores a last primary key KEY.1-KEY.N received in step 1808 in a first exemplary restart file RSTRT.001 as further discussed in reference to FIG. 21.

The client 120 determines in step 1812 whether the remote server 130 has provided all selected primary keys KEY.1-KEY.N of record updates indicated by the remote server 130 to have been performed within the time bounds of the exemplary first key request message KRQ.001. When the client 120 determines in step 1812 that the remote server 130 has not appear to have provided all selected primary keys KEY.1-KEY.N of record updates indicated by the remote server 130 to have been performed within the time bounds of the exemplary first key request message KREQ.001, the client 120 proceeds to perform another iteration of step 1806 and to issue a second key request message KEQ.002 that specifies the current value of last primary key KEY.1-KEY.N as stored in the first restart file RSTRT.001 as a reference point in an ordered sequence of values of primary keys KEY.1-KEY.N to be applied by the remote server 130 in response to receipt of the second key request message KREQ.002.

Alternatively, when the client 120 determines in step 1812 that the remote server 130 has appeared to have provided all selected primary keys KEY.1-KEY.N of record updates indicated by the remote server 130 to have been performed within the time bounds of the exemplary first key request message KREQ.001, the client 120 proceeds onto step 1814 and enables the threads started in step 1804 to complete downloading of record updates indicated by the primary keys KEY.1-KN received in one or more executions of steps 1808 and optionally step 1828.

The client 120 proceeds from step 1814 onto step 1816 to archive and query all records REC.1-REC.N referenced in the record updates received by the threads started in the most recent performance of step 1804. The client 120 proceeds from step 1816 onto step 1818 to get all records indicated as deleted in accordance with the record updates received by the threads started in the most recent performance of step 1804. The client 120 proceeds from step 1818 onto step 1820 and to perform alternate computational processes, to include optionally returning to perform step 1802.

Referring now to step 1802, when the client 120 determines that itself is in a restart mode, the client 120 proceeds on to step 1822. In step 1822 the client 120 starts the pre-specified number of N threads that operate to request record updates from the remote server 130 that are identified by primary keys KEY.1-KEY.N received by the client 120 in steps 1808 and 1828.

The client 120 proceeds on to step 1824 from step 1822 and to direct the threads started in step 1822 to request record update information referenced by primary keys KEY.1-KEY.N previously received one or more previous executions of step 1808 but not yet applied by the client 120 to request record updates from the remote server 130.

The client 120 proceeds from step 1824 to step 1826 generates and transmits a third exemplary key request message KREQ.003, as further discussed in reference to FIG. 21, via the network 100 and to the remote server 130. The third exemplary key request message KREQ.003 may optionally specify a total key count limitation, expressed by the exemplary first count value KCNT.001, to be imposed by the remote server 130 in responding to the third exemplary key request message KREQ.003 whereby the remote server 130 is directed to limit a total count of primary keys KEY.1-KEY.N to be provided to the client 120 in response to the third exemplary key request message KREQ.003. The exemplary key request message KREQ.001 specifies time bounds of update time-date data to be applied by the remote serve 130 in selecting primary keys KEY.1-KEY.N to be sent in response to receipt of the exemplary key request message KREQ.001. The exemplary key request message KREQ.001 further includes the specific current value of the primary key KEY.1-KEY.N that is stored in the first exemplary restart file RSTRT.001.

In step 1828 the client 120 receives an exemplary key response message KRESP.001 and stores the primary keys KEY.1-KEY.N harvested from the exemplary key response message KRESP.001 to the client disk memory 1201 of a client disk memory module 120J of the client 120, as shown on FIG. 23, for access by a designated thread as started in step 1804.

In step 1829 the client 120 records, and make accessible to the record update retrieving threads of the method of FIG. 18, location data and/or pathway data LOC.001-LOC.N that is applied by the client 120 to enable these threads to find and store the primary keys KEY.1-KEY.N harvested from the exemplary key response messages KRESP.001-KRESP.N for application in retrieving record update information from the remote server 130 and/or from resources accessible via the network 100, as executed at least in steps 1822, 1804 and 1814.

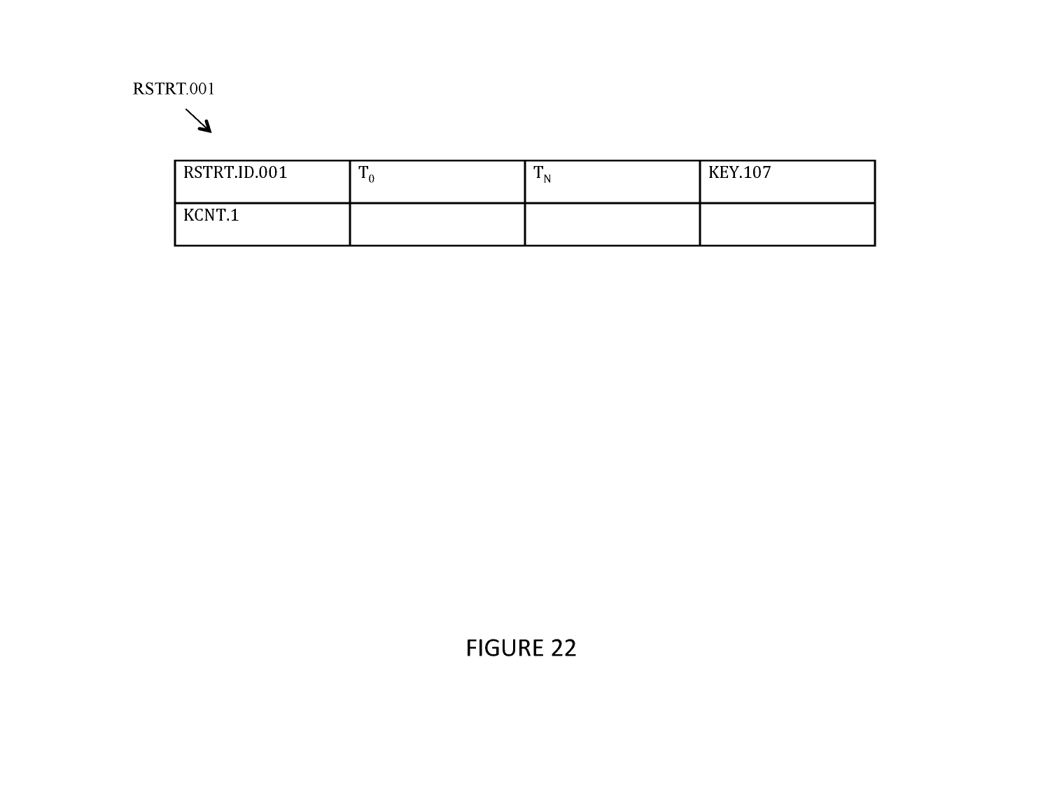

In step 1830 the client 120 stores and refreshes the exemplary restart file RSTRT.001 with the last primary key KEY.1-KEY.N received in step 1828 as further discussed in reference to FIG. 22.

The client 120 proceeds from 1830 to step 1832 and to determine whether the remote server 130 has provided all selected primary keys KEY.1-KEY.N of record updates indicated by the remote server 130 to have been performed within the time bounds of the exemplary first key request message KRQ.001 of step 1806. When the client 120 determines in step 1832 that the remote server 130 has not appear to have provided all selected primary keys KEY.1-KEY.N of record updates indicated by the remote server 130 to have been performed within the time bounds of the exemplary first key request message KREQ.001, the client 120 proceeds to perform another iteration of step 1826 and to issue additional key request messages KEQ.004-KREQ.004-KREQ.N that specifies the current value of last primary key KEY.1-KEY.N as stored in the first restart file RSTRT.001 as a reference point in an ordered sequence of values of primary keys KEY.1-KEY.N to be applied by the remote server 130 in response to receipt of the most recently issued key request message KREQ.002-KREQ.N.

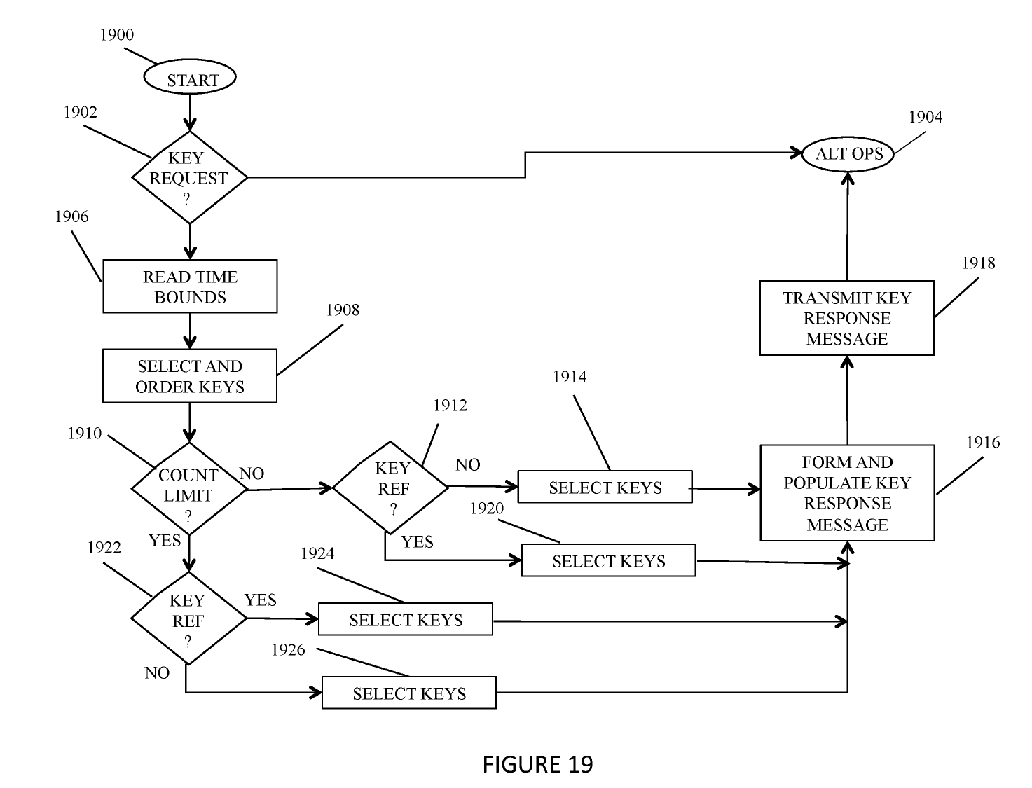

Referring now generally to the Figures and particularly to FIG. 19, FIG. 19 is a flowchart of aspects of the remote server 130 in interaction with the client 120 in accordance with the client operations of the method of FIG. 18. In step 1900 the remote server 130 checks for incoming electronic messages received via the network 100 and in step 1902 determines whether a key request message KREQ.001-KREQ.N has been received from the client 120. When the remote server 130 determines in step 1902 that an unread key request message KREQ.001-KREQ.N has not been received from the client 120, the remote server 130 proceeds on to step 1904 and to perform alternate computational operations, to include returning to additional executions of step 1902.

In the alternative, when the determines in step 1902 that an unread key request message KREQ.001-KREQ.N has not been received from the client 120, the remote server 130 proceeds on to step 1906 to read the time bounds data from the key request message KREQ.001-KREQ.N (hereinafter, “the instant key request message KREQ.001-KREQ.N”) received and detected by the remote server 1902. In step 1908 the remote server 130 selects and orders all primary keys KEY.1-KEY.N of records REC.1-REC.N indicated to the remote server 130 as having been updated within the time bounds indicated by the instant key request message KREQ.001-KREQ.N.

In step 1910 the remote server 130 determines whether the instant key request message KREQ.001-KREQ.N includes a count value, as expressed by the exemplary first count value KCNT.001, of a primary key KEY.1-KEY.N that will be applied in any performance of step 1924 and 1926. When the remote server 130 determines in step 1910 that the instant key request message KREQ.001-KREQ.N does not include a key count value the remote server 130 proceeds from step 1910 to step 1912

In step 1912 the remote server 130 determines when the instant key request message KREQ.001-KREQ.N includes a reference value of a primary key KEY.1-KEY.N that will be applied in step 1920. When the rs120 determines in step 1912 that the instant key request message KREQ.001-KREQ.N does not include a reference value of a primary key KEY.1-KEY.N, the remote server 130 proceeds on to step 1914 and selects all primary keys KEY.1-KEY.N selected and ordered in step 1908. In step 1916 the remote server 130 forms a first exemplary key request response message KRESP.001 and populates the first exemplary key request response message KRESP.001 with the primary keys KEY.1-KEY.N selected in step 1914.

In the alternative outcome to step 1912, when the rs120 determines in step 1912 that the instant key request message KREQ.001-KREQ.N does include a reference value of a primary key KEY.1-KEY.N (hereinafter, “the reference key KEY.1-KEY.N”), the remote server 130 proceeds on to step 1920 and selects all primary keys KEY.1-KEY.N selected and ordered in step 1908 and listed in sequence of step 1908 beyond the reference key KEY.1-KEY.N. In an alternative execution of step 1916 the remote server 130 proceeds from step 1916 to form and populate the first exemplary key request response message KRESP.001 with all of the primary keys KEY.1-KEY.N selected in step 1920.

In the alternative outcome to step 1910, when the remote server 130 determines in step 1910 that the instant key request message KREQ.001-KREQ.N does include a key count limitation, as expressed by the exemplary first count value KCNT.001, the remote server 130 proceeds from step 1910 to step 1922. In step 1922 the remote server 130 determines when the instant key request message KREQ.001-KREQ.N includes the reference key KEY.1-KEY.N that would be applied in step 1924. When the rs120 determines in step 1922 that the instant key request message KREQ.001-KREQ.N does include the reference key KEY.1-KEY.N, the remote server 130 proceeds on to step 1924 and selects up to a total count of primary keys KEY.1-KEY.N equal to the count, as expressed by the exemplary first count value KCNT.001, read from the instant key request message KREQ.001-KREQ.N of step 1906 from the listing of primary keys KEY.1-KEY.N selected and ordered in step 1908 and listed beyond the reference key KEY.1-KEY.N in that sequenced key listing generated in step 1908. In a yet other alternative execution of step 1916 the remote server 130 proceeds from step 1924 to form and populate the first exemplary key request response message KRESP.001 with all of the primary keys KEY.1-KEY.N selected in step 1924.

In the alternative outcome to step 1920, when the remote server 130 determines in step 1920 that the instant key request message KREQ.001-KREQ.N does not include the reference key KEY.1-KEY.N, the remote server 130 proceeds on to step 1926 and selects up to a total count of primary keys KEY.1-KEY.N equal to the count, as expressed by the exemplary first count value KCNT.001, read from the instant key request message KREQ.001-KREQ.N of step 1906 from the listing of primary keys KEY.1-KEY.N selected and ordered in step 1908. In a still other alternative execution of step 1916 the remote server 130 proceeds from step 1926 to form and populate the first exemplary key request response message KRESP.001 with all of the primary keys KEY.1-KEY.N selected in step 1926.

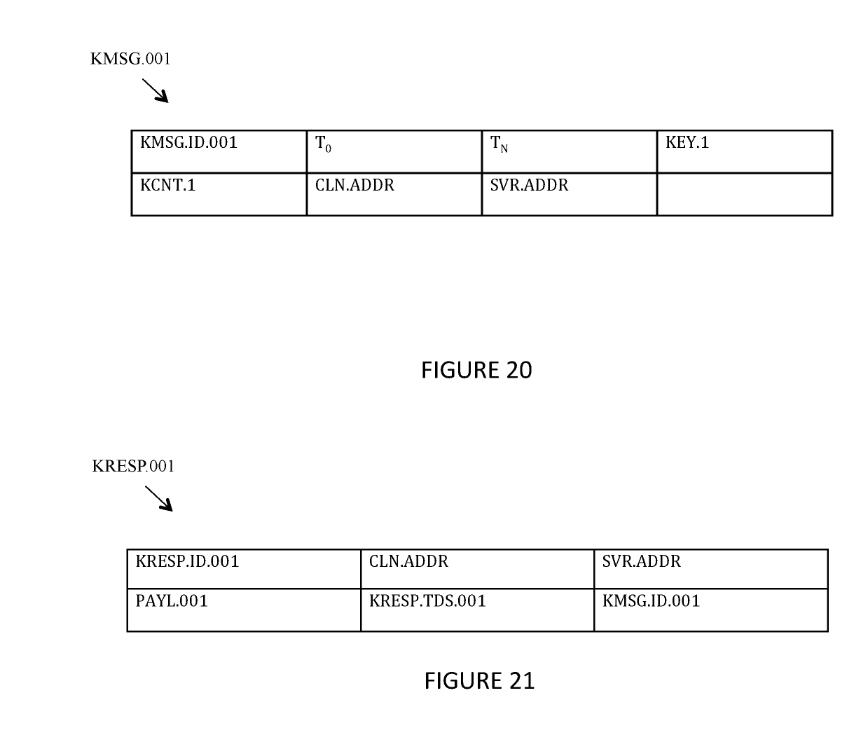

Referring now generally to the Figures and particularly to FIG. 20, FIG. 20 is a block diagram of the exemplary first primary key request message KREQ.001 transmitted from the client 120 to the remote server 130. The exemplary first primary key request message KREQ.001 includes: (a.) a unique key request message identifier KMSG.ID.001, such that the client 120 and the remote server 130 may appropriately identify and respond to the key request message KREQ.001; (b.) a first date time stamp T.sub.0, as a beginning time boundary for the query; (c.) a second date time stamp T.sub.N, as an ending time boundary for the query; (d.) the optional reference key KEY.1-KEY.N; (e.) the optional exemplary first count value KCNT.001 (f.) the address of the client 120 CLN.ADDR as the sending address; and (g.) the address of the remote server 130 SRV.ADDR as the recipient address.

Referring now generally to the Figures and particularly to FIG. 21, FIG. 21 is a block diagram of the exemplary first server response message of KRESP.001. The exemplary first server response message of KRESP.001 includes (a.) a unique server response message identifier KRESP.ID.001, such that the client 120 and the remote server 130 may appropriately identify and process the first server response message of KRESP.001; (b.) the address of the client 120 CLN.ADDR as the sending address; and (c.) the address of the remote server 130 SRV.ADDR as the recipient address; (d.) a first exemplary payload PAYL.001 of primary keys KEY.001-KEY.N populated into the first server response message of KRESP.001 by the remote server 130 in step 1916 of the method of FIG. 19; (e.) an optional citation of the unique key request message identifier KMSG.ID.001 to which instant exemplary first server response message of KRESP.001 is responding to; and (f.) a first server key request server message time date stamp KMSG.ID.001 that indicates a time of generation of the exemplary first server response message of KRESP.001.

Referring now generally to the Figures and particularly to FIG. 22, FIG. 22 is a block diagram of the exemplary first restart file RSTRT.001. The exemplary first restart file RSTRT.001 includes: (a.) a unique key restart file identifier RSTRT.ID.001, such that the client 120 may appropriately identify and apply the first restart file RSTRT.001; (b.) a first date time stamp T.sub.0, as a beginning time boundary for the current query; (c.) a second date time stamp T.sub.N, as an ending time boundary for the current query; and (d.) the optional reference key KEY.1-KEY.N; and (d.) the optional exemplary first count value KCNT.001.

Referring now generally to the Figures and particularly to FIG. 23, FIG. 23 is a block diagram of the client memory 120G showing the record key lists 2200.A-2200.N as harvested from the server response messages KRESP.001-KPESP.N and stored in the client memory 120G. The client memory 120G includes and stores (a.) a plurality of key request messages KREQ.001-KREQ.N as separately generated by the client 120 in individual executions of step 1806 of the method of FIG. 18; (b.) a plurality of key request response messages KRESP.001-KRESP.N as transmitted by the remote server 130 in separate executions of step 1918 of the method of FIG. 19; (c.) a plurality of key value payloads PAYL.001-PAYL.N as extracted from one or more of key request response messages KRESP.001-KRESP.N; (d.) a plurality of restart files restart file RSTRT.001-RSTRT.N; AND (e.) location data and/or pathway data LOC.001-LOC.N, wherein each discrete location data and/or pathway data LOC.001-LOC.N informs the threads of the method of FIG. 18 where and how to find one of the plurality of key listings KLIST.001-KLIST.N, wherein each key listing KLIST.001-KLIST.N preferably stores a plurality of primary record keys KEY.1-KEY.N that were harvested by the client 120 from one or more key request response messages KRESP.001-KRESP.N.

FIG. 23 further presents an additional memory of the client 120, namely a client disk memory module 120J that is bi-directionally communicatively coupled with the client bus 130C and thereby to client system memory 120G. The client disk memory 1201 of the client disk memory module 120J stores a plurality of key listings KLIST.001-KLIST.N, wherein each key listing KLIST.001-KLIST.N preferably stores a plurality of primary record keys KEY.1-KEY.N that were harvested by the client 120 from the key request response messages KRESP.001-KRESP.N in step 1808 and 1826 and written into the key listings KLIST.001-KLIST.N as stored on the client disk memory 1201. The client 120 makes the primary record key KEY.1-KEY.N content accessible to the record update threads of the method of FIG. 18 for at least the purpose of requesting record update information from the remote server 130.

(d) a plurality of key lists each containing primary keys KEY.1-KEY.N extracted from key value payloads PAYL.001-PAYL.N and made available for threads from which to request record update information from the remote server 130 in at least step 1814 of the method of FIG. 18;

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based herein. Accordingly, the disclosure of the embodiments of the invention is intended to be illustrative, but not limiting, of the scope of the invention, which is set forth in the following claims.

1. A database management system, comprising:
a processor comprising hardware; and
a memory storing a database management system adapted to update a first database with information received via an electronic communications network and the memory further storing executable instructions that, when executed by the processor, perform operations comprising:
a. establishing bi-directional communications session via the network with a remote database server (“the remote server”),
b. generating a time bound record key ordered query;
c. submitting the time bound record key ordered query to the remote server;
d. receiving a plurality of record keys from the remote server;
e. distributing the plurality of record keys among a plurality of key list files;
f. initiating a plurality of replication processes, wherein each replication process runs requests record update information via the network identified by record keys contained within each successively selected key list; file and
g. updating a plurality of records of the first database with record update information received via the network by iterating in parallel through the plurality of replication processes.

2. The database management system of claim 1, wherein the number of the replication processes of the plurality of replication processes running in parallel is predetermined.

3. The database management system of claim 1, wherein the operations further comprise distributing each record key to only one key list file.

4. The database management system of claim 1, wherein the operations further comprise the time bound record key ordered query directing an ordering of the plurality of record keys by primary key value prior to receipt by the database management system.

5. The database management system of claim 1, wherein the operations further comprise receiving the plurality of record keys ordered by primary key value.

6. The database management system of claim 1, wherein the operations further comprise receiving ordering the plurality of key values by primary key value prior to distribution of the key values among a plurality of key list files.

7. The database management system of claim 1, wherein the operations further comprise the time bound record key ordered query directing a maximum count of record keys to be provided in response to the time bound record key.

8. The database management system of claim 1, wherein the operations further comprise the time bound record key ordered query specifying a maximum count of record keys to be provided in response to the time bound record key.

9. The database management system of claim 1, wherein the operations further comprise forming a restart file comprising an initial time-date datum, a final time-date datum of the time bound record key ordered query and a key value associated with a record update information most recently received via the network in response to the time bound record key ordered query, wherein the restart file is consistently updated with the key value of the most recently received record update information.

10. The database management system of claim 1, wherein the operations further comprise populating the key list files with substantively approximately equal counts of record keys.

11. The database management system of claim 1, wherein the operations further comprise populating the key list files with a quantity of record keys no greater than 1 plus the average number of record keys distributed to each key list file.

12. The database management system of claim 1, wherein the operations further comprise distributing the plurality of record keys in round robin fashion to the key list files.

13. The database management system of claim 1, wherein the operations further comprise at least one replication process being an independent job initiated by a computational thread.

14. The database management system of claim 1, wherein the operations further comprise at least one replication process is executed by a computational thread.

15. The database management system of claim 1, wherein the operations further comprise receiving and applying at least one record key that identifies a record of a relational database.

16. The database management system of claim 1, wherein the operations further comprise receiving and applying at least one record key that identifies a record of an object-oriented database.

17. The database management system of claim 1, wherein the operations further comprise:
h. detecting a halt in the receipt of record update information;
i. reinitiating a plurality of replication processes, wherein each replication process runs requests record update information via the network identified by record keys that are both contained within the key list files and of equal or higher value than the key value stored in the restart file; and
g. updating a plurality of records of the first database with record update information received via the network by the reinitiation of iterating in parallel through the plurality of replication processes.

18. The database management system of claim 17, wherein the operations further comprise receiving and applying at least one record key that identifies a record of a relational database.

19. The database management system of claim 17, wherein the operations further comprise receiving and applying at least one record key that identifies a record an object-oriented database.

20. The database management system of claim 17, wherein the operations further comprise at least one replication process is comprised within a computational thread.
